(19) United States
(12) Patent Application Publication
(10) Pub. No.: US 2007/0067772 A1
(43) Pub. Date: Mar. 22, 2007

(54) Tools and methods for task management

(76) Inventor: Jorge M. Bustamante, Irving, TX (US)

Correspondence Address: Mr. Christopher John Rourk;Jackson Walker LLP, 901 Main Street, Suite 6000, DALLAS, TX, 75202, US

(21) Appl. No.: 11/447,703

(22) Filed: Jun. 6, 2006

Related U.S. Application Data
(60) Provisional application No. 60/688,966, filed on Jun. 9, 2005.

(51) Int. Cl. G06F 9/46

(52) U.S. Cl. 718/100

(57) ABSTRACT

A method for managing tasks with a system allows a task Initiator and a task Performer to negotiate the terms and acceptance of tasks, and then tracks performance and acceptance of completion of the tasks. A task monitor is provided which is split into two regions, the first region displaying tasks requiring action form the particular user, both as a Task Assignor and as a Task Performer, and a second region displaying tasks which require action by others, both as Task Performers and Task Assignors. A task available time display is provided for potential Task Performers and provides a graphical representation of the total time of the potential Task Performers, which shows the time allotted for assigned tasks and the remaining time available for performance of new tasks. A recurring task feature is provided for assigning recurring tasks, which fully integrates with the method of assigning, negotiating, accepting and completion of tasks. A feature is provided for assigning tasks to others outside of the organization in which the task Assignor is operating, creating a user account for the new potential performer in the database for the task management system. The new performer can then also create accounts for others to whom the new performer wishes to assign tasks, creating new accounts having full functionality to create user accounts for others to whom the new users wish to assign tasks.

### RELATED APPLICATIONS

This application claims priority to U.S. Provisional Application 60/688,966, filed Jun. 9, 2005, entitled “TOOLS FOR METHODS OF TASK MANAGEMENT,” which is hereby incorporated by reference for all purposes, and is related to U.S. patent application Ser. No. 10/682,356 filed Oct. 9, 2003, which is commonly owned and assigned with the present application.

### FIELD OF THE INVENTION

The present invention relates in general to methods for task management, and in particular to tools for use in task management methods.

### BACKGROUND OF THE INVENTION

Processes for assigning tasks using conventional contact managers often provide a listing of tasks assigned in a spreadsheet type format listing, such as the task monitor shown in FIG. 6 and described below. A user must search through the various assigned tasks to ascertain those open tasks which have been assigned to the particular user and which have yet to be performed, and those task which have been assigned to others. This is often cumbersome, and when numerous tasks have been assigned, tasks requiring action from the user often being easily overlooked.

When assigning tasks, other tasks must be reviewed to determine the available time of potential task performers. This is also cumbersome and time consuming when numerous tasks have been assigned and the assigned tasks are displayed in a spreadsheet type format, such as the task monitor shown in FIG. 6 and described below. This requires a user to survey the tasks that have been assigned and which are not yet performed to ascertain the remaining amount of time potential task performers have remaining to perform new tasks within requisite time periods for performance of new tasks, and then determine optimal use of available time in assigning various new tasks to particular task performers. These and other problems limit the usefulness of such existing processes.

### SUMMARY OF THE INVENTION

In accordance with an exemplary embodiment of the present invention, a task monitor is provided that lists tasks which are the responsibility of a user, as either a Task Assignor or a Task Performer. The task monitor can be split into two screens, or regions, the first region displaying tasks requiring action form the particular user, either as a Task Assignor or as a Task Performer. In a second region of the display, tasks are displayed which require action by others, either as Task Performers or Task Assignors.

A task available time display is also provided in another exemplary embodiment of the present invention for Task Performers, which can be displayed as part of a task assignment display used for creating tasks for assignment. The display can be provided both to a Task Assignor for use in selecting a Task Performer, and to the Task Performer for use in determining whether to accept the particular task. The task available time display can be a graphical representation of the total time of the potential Task Performers, which shows the time allotted for assigned tasks and the remaining time available for performance of new tasks.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a flow chart depicting a broad overview of a method assigning and tracking tasks in accordance with an exemplary embodiment of the present invention;

FIG. 2 is a flow chart depicting a broad overview of an example of an Initiator and a Performer assigning and managing tasks in accordance with an exemplary embodiment of the present invention;

FIGS. 3A through 3D together provide a flow chart depicting a process that enables an Initiator to assign and track a task to a Performer in accordance with an exemplary embodiment of the present invention;

FIGS. 4A through 4H together provide a flow chart depicting a process that enables an Initiator to assign and track a task to a Performer in accordance with an exemplary embodiment of the present invention;

FIG. 5 is a flow chart depicting a process for defining and assigning a future task for delivery to a Performer at a later date in accordance with an exemplary embodiment of the present invention;

FIG. 6 is a screen shot of a computer monitor of a system depicting an example of a task monitor for the process in accordance with an exemplary embodiment of the present invention;

FIG. 7 is a screen shot of a computer monitor of a system depicting an example of a task monitor having a split screen, showing two separate regions for display of tasks in accordance with an exemplary embodiment of the present invention;

FIGS. 8A and 8B are a representation of a task available time display is provided for potential Task Performers in accordance with an exemplary embodiment of the present invention;

FIG. 9 is a representation of a data input screen showing features for entry of recurring tasks in accordance with an exemplary embodiment of the present invention;

FIG. 10 is a flow chart representing a method of task management described herein further includes a feature for assigning tasks to others who are not users of the system of task management in accordance with an exemplary embodiment of the present invention;

FIG. 11 is a representation of a task entry screen in accordance with an exemplary embodiment of the present invention; and

FIG. 12 is a flow chart depicting one embodiment of a task cycle in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures can not be to scale and certain components can be shown in generalized or schematic form and identified by commercial designations in the interest of clarity and conciseness.

In one exemplary embodiment of the present invention, a system is provided to control the management of a task between an Initiator and a Performer, from defining the task to completing and closing of the task. As used herein, a system can be implemented in hardware, software, or a suitable combination of hardware and software, and can be one or more software systems operating on a general purpose processing platform. As used herein, a hardware system can include discrete semiconductor devices, an application-specific integrated circuit, a field programmable gate array, a general purpose processing platform, or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

The Initiator of a task and the Performer of a task negotiate the parameters of the tasks being assigned, so as to avoid problems that arise when an Initiator merely assigns a task to another person. After a task is negotiated, the system tracks the performance of the task, so that the Initiator and the Performer can actively respond to the tracking feature of the task management system, so as to remove the possibility of someone claiming they did not receive messages regarding assignment and performance of the tasks. Management of a task is controlled and tracked, providing individual accountability for the task management process from origination of the task, to negotiating the scope and temporal limits of the task, to assigning and accepting the task, to monitoring and confirming actual performance of the task, and to completing and confirming completion of the task. In one exemplary embodiment, the present invention facilitates interaction of the Initiator and the Performer for assigning, tracking and confirming completion of tasks. Electronic messaging provides communication between the Initiator and the Performer, unless other communication means are required to notify the Initiator or the Performer of an awaiting electronic message.

A user assigning task can quickly review the graphical representation showing the currently allotted time and available time for each user in a work group, or selected task performers from a work group, and quickly determine optimal use of available time in assigning various new tasks to particular task performers. All the potential performers in one or more work groups or business organizations are preferably shown in a single display, and others can be selectively not displayed or displayed in the task available time display.

A recurring task feature is provided for assigning recurring tasks. The recurring task feature provides a graphical display in which recurring task can be scheduled without requiring manual reentry of data for task which often recur. This feature fully integrates with the method of assigning task described and shown herein, such that task result review and task approval features can be selectively enabled or disabled for particular recurring tasks assigned.

The method of task management described herein further includes a feature for assigning tasks to others who are not users, such as those outside of the organization in which the task Assignor is operating. A task Assignor can select a potential Task Performer who is not a user, that is, who does not have a user account in the system for assigning tasks. A user account is created in the task management system by the Assignor creating a new Task Performer. Then, if an electronic message is forwarded to the new task performer inviting the new task performer to join the system for task management. The new task performer can then download and install software for the task management system on the new task performer's computer, and an account is created in a database for the task management system. Preferably, the electronic message will include a link to which the new account performer is invited to click on to view the new task assigned, which once activated, will automatically download and install the fully functional software for a new user to review his tasks, assign new tasks, complete, monitor and approve task. The database can be a central database or a distributed database, but the new task performer's assigned tasks are available for review, acceptance, negotiation, and performance entries in the task management system. The new user account can provide a temporary activation, such as an activation for a period of time on a trial basis, or the task Assignor initiating the task and the invitation to the system can allocated a user license to the new task performer. In other embodiments, the software downloaded to the new task performer can be a version of limited functionality, such as commonly termed a light version of software, or the software can be a fully functional installation, depending upon options selected by the Task Assignor in assignment of the task. Preferably, the new user can assign tasks to others, creating new user accounts initiating an electronic message containing an invitation with a link to automatically download the task management software with on click on the link.

A method for managing tasks with a system is provided which during assignment of tasks allows a task Initiator, the person creating the task, and a task Performer, who is the person assigned to perform the task, to negotiate the terms, or parameters, of the tasks being assigned. An Initiator does not merely assign a task to a subordinate, or Performer, but rather the Initiator proposes initial task parameters, and then the Performer either accepts the task with the initial proposed parameters, or the Performer counter-proposes different terms, or parameters. After a task is assigned, the system tracks the performance of the task, forcing both the Initiator and the Performer to actively respond to the tracking feature of the task management system, removing the possibility of someone claiming they did not receive messages regarding assignment and performance of the tasks. The various steps for managing the tasks according the present invention are set forth herein.

The method for managing tasks with a system includes steps for defining the parameters of tasks, initiating assignment of the tasks, negotiating acceptance of the tasks, confirming acceptance of the tasks, tracking performance of the tasks, and confirming performance and completion of the tasks. An Initiator will first define the initial parameters of a task, or of multiple tasks which comprise a project. The Initiator will then initiate assignment of the task to a Performer. Next, the Initiator and Performer will negotiate the parameters and acceptance of the task. Completion of various parameters of the task are tracked and confirmed by the Initiator and Performer as the task is performed. Upon completion of the tasks, both the Performer and the Initiator confirm completion of the task.

The method for managing tasks with a system includes steps for assigning tasks among a task Initiator and a task Performer and for tracking the individual responsibility of the Performer and Initiator as they assign, negotiate, perform and complete the task. Tasks can be assigned to one's self or to others. Tasks can be assigned to a superior, a subordinate or a peer, regardless of their hierarchical status. The Initiator specifies the parameters of the task to be assigned, which define the various terms of the task to be completed. Preferably, the essential parameters for a task generally include a description of the task, the time for performance of the task, and the Performer. Other parameters for a task can include the amount of time to devote to the task, duplicate copies of task assignments to other recipients, and attachments of documents to electronic correspondence associated with assignment, acceptance and monitoring of performance of the task. The parameters of the tasks are negotiated between the Initiator and the Performer. The Initiator does not force acceptance of a task onto a Performer in one exemplary embodiment, but rather the parameters of the tasks can be negotiated until the Initiator and the Performer both accept the terms, or parameters, of the tasks being assigned. This provides accountability for tasks which are individually accepted by the Performer. After acceptance of a task by a Performer, the method provides notification to the Performer and the Initiator of the status of the task during various stages, such as completion of particular parameters or sub-tasks comprising the task, and provides tracking of individual accountability of the Initiator and the Performer. Once a task is completed, the method tracks that the Performer notifies the Initiator of completion of the task and that the Initiator confirms closing of the task by notification to Performer.

The following is a summary of steps that can be used to describe a task from assigning, negotiating, accepting, completing and closing in accordance with an exemplary embodiment of the present invention. First, an Initiator assigns a task to a Performer. When assigning the task, the Initiator describes scope of the task and the desired completion date. The Initiator can also describe the amount of time that the Performer should spend performing the task.

The Performer is then notified of the pending task assignment requested by Initiator, and responsibility shifts to the Performer to accept the task as assigned by the Initiator, to propose to the Initiator different terms for the task, or to do nothing. If the Initiator specifies the amount of time that Performer should spend on the task, then the Performer must agree on the due date for the task, and optionally, on the amount of time to devote to the task. The task request can also be negotiated. For example, if the Performer accepts the task on the terms proposed by the Initiator, the Performer has become individually accountable to complete the task according to the accepted terms for the task. Likewise, if the Performer does not accept the terms proposed by Initiator, then the Performer can propose new terms to Initiator. The task request is returned to the Initiator for review, acceptance or for changes to be made to the proposed task request. This process of task proposing task parameters going back and forth between the Initiator and the Performer until either of the parties accepts the terms of the other party, so that no party can forces its terms on the other. The terms offered by the proposing party have to be accepted by the party receiving the proposal. If the terms are changed, then the entire task request returns to the other party as a counter offer. It becomes binding only after one party accepts the terms without changing any of the terms proposed by the other party. As the task is negotiated back and forth, it remains the responsibility of the proposing party sending the proposed task request until the receiving party acknowledges receipt, without regard to whether the proposing party is the original Initiator or the proposed Performer of the pending task request.

If the Performer decides to do nothing with the task request, the system notifies the Initiator that the Performer has not acted on the task request after a suitable time interval after the task request is delivered to the Performer for review.

Once the Performer and Initiator agree on the terms for a task request, the task assignment is binding on the Performer in this exemplary embodiment of the invention. At this time, the task is in progress by Performer and becomes the responsibility of the Performer to notify the Initiator when completed.

When the Performer completes the Task, the Performer notes that the task has been completed and a system notifies Initiator of the task completion. The task is the responsibility of the Performer until Initiator acknowledges that he has been notified of the task completion.

The Task is completed for Performer when Initiator acknowledges receipt of notification of completion of the task.

If the Initiator determines that the task was not satisfactorily performed by the Performer, the Initiator can restart the process by assigning a new task, but it is the responsibility of Initiator to restart the process. As long as Performer does not receive notice from the Initiator that a new task is being started, the task is completed and the Performer is released of his obligation to Initiator.

The enforcement of the process is achieved by a combination of reports and screen messages, including a task monitor screen. The system applies time stamps to a record of each step throughout the process. A report can be produced showing the time and the date for each step of a task, such as the amount of time taken to open, to read, to respond to a task request, and to perform each step of the task, thus providing a supervisor a method to measure the performance and responsiveness of a subordinate according to specific temporal measurements. The process can also be customized to produce real time actions like a flashing text or bold type face to accommodate different ways of enhancing enforcement. A record of each step of the process provides reports useful for auditing both the Performer and the Initiator.

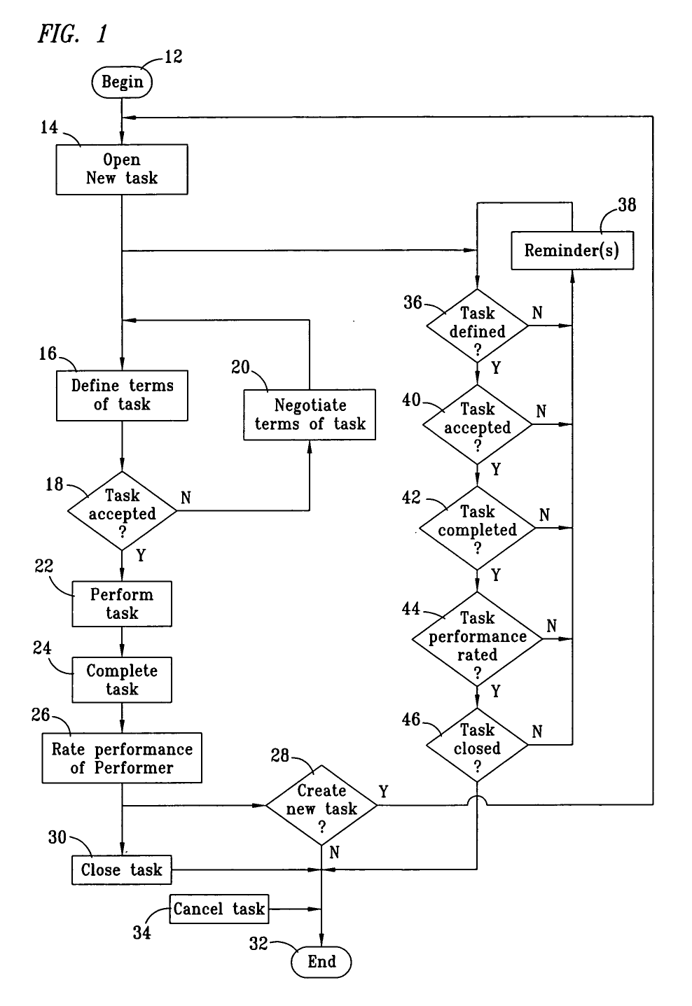

FIG. 1 is a flow chart depicting a broad overview of a method for assigning and tracking tasks according to an exemplary embodiment of the present invention. In step 12 the process begins and then proceeds to step 14, in which a new task is opened by entering task parameters into various fields in a task creation screen displayed on a computer monitor. In step 16 the terms of the task are defined. The terms would typically include, but are not necessarily limited to, various parameters of the tasks, such as a listing of various components of the task, the scope of the work to be performed, the due date of the task, the person or entity who is to perform the task, and optionally the amount of time allocated to perform the task. After step 16 the process will proceed to decision step 18, and determine whether the task has been accepted by the Performer. If in step 18 it is determined that the task has not been accepted, the process will proceed to step 20 of negotiating acceptance of the task, which proceeds to step 16 of defining the terms of the task. In general, both the Initiator and the Performer can propose alternate parameters for the task until both the Initiator and the Performer have accepted the terms of the task as determined in step 20, then the process proceeds to step 22. In step 22 the task is performed. After the task is performed, the Performer will complete the task in step 24 by noting the task as complete. The Initiator will then rate the Performer's performance of the task in step 26, and then the Initiator closes the task in step 30. After rating performance of the task, the Initiator is provided the opportunity to create a new task in step 28, and a new task can be created if the task being closed was not performed to the Initiator's satisfaction. If a new task is to be created, the process will proceed to step 14, and a new task will be opened. Whether or not a new task is created after step 26, the current task will be closed in step 30 and the process will end in step 32.

The above-identified process will be monitored by a system during completion of various steps. Simultaneously, upon initiating step 16, the process will proceed to decision step 36 and initiate a monitoring process which comprises steps 36 through 46. After a suitable time delay from the task being opened in step 14, the process will move to step 36 to determine whether the terms of the task have been defined. If the parameters for the task have not been defined according to step 16, after the predetermined time delay, the process will proceed to step 38 and forward a reminder to the Initiator to indicate that the task has not been defined. Next, the process will proceed to step 40 and determine whether the task has been accepted. If the task has not been accepted as determined in step 40, the process proceeds to step 38 and a reminder is forwarded to the Performer and the Initiator. The counter proposals between the Initiator and the Performer can continue until either of the parties accepts the task as proposed by the other, without proposing new terms to the proposing party. Once the task has been accepted, the process proceeds to step 42 and determines whether the task has been noted as completed by the Performer. If the Performer has not noted the task as being completed after a suitable time delay, the process proceeds to step 38 and sends a reminder to the Performer and the Initiator regarding the task not having been noted as completed by the Performer. After a suitable time delay after the task has been completed, the process will proceed to step 44 and determine whether the quality and timeliness of the Performer's performance in completing the task have been rated by the Initiator. If the Initiator has not rated the Performer's performance in completing the assigned task after the predetermined time delay from the Performer noting completion of the task, a reminder will be forwarded to both the Initiator and the Performer in step 38. After a predetermined time delay from the rating of the Performers performance in step 26, the process will proceed to step 46 and determine whether the task has been closed. If the task has not been closed after expiration of the predetermined time delay, the process will forward the reminder of step 38. After the task is detected as closed in step 46, the process will proceed to the end step 32.

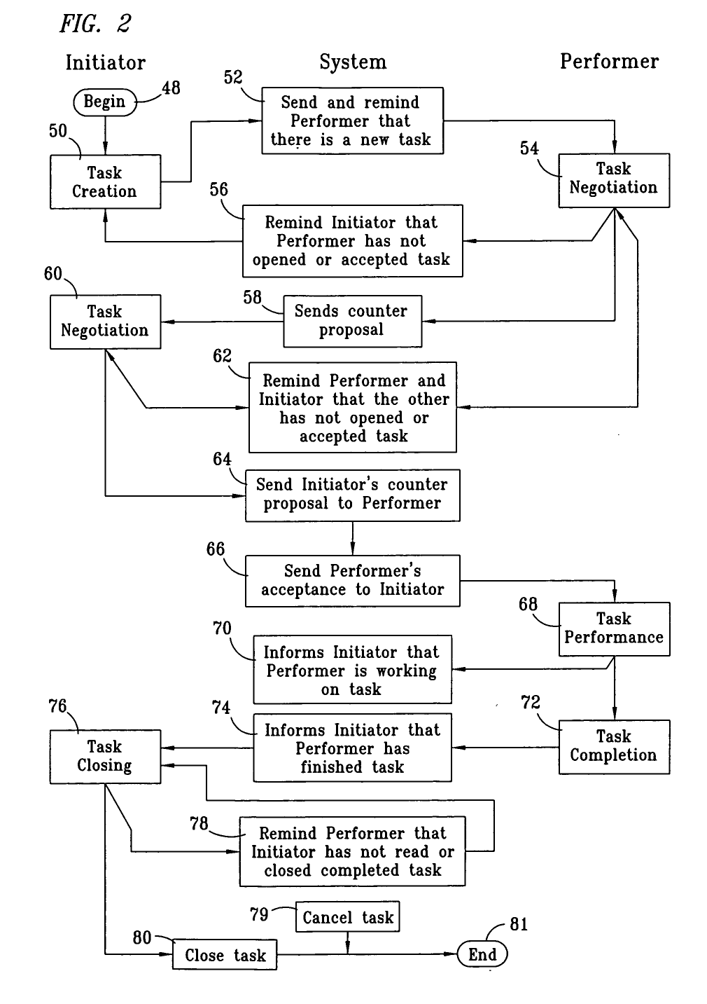

FIG. 2 is a flow chart depicting an example of the interface between an Initiator and a Performer for assigning and managing tasks in accordance with an exemplary embodiment of the present invention. The process begins in step 48 and proceeds to step 50, in which the task is created. Then in step 52 a message is sent to the Performer that there is a new task waiting to be opened in the Performer's task monitor. After a predetermined time delay, later messages will be forwarded to the Performer as reminders in step 52. After the Performer reviews the task parameters, if the Performer would like to change the task parameters, negotiation can begin in step 54. In step 56 the process will forward a reminder to the Initiator that the Performer has not opened or accepted the task. If the Performer determines to not accept the task as created by the Initiator, in step 58 the Performer sends the Initiator a counter proposal. A task negotiation step is represented by step 60. In step 60 the Initiator can make counter-proposals to the Performer's proposal to modify the task. In step 62 reminders are sent to the Initiator and the Performer regarding whether the other has opened or accepted a task proposal. In step 64 the Initiator's counterproposal is sent to the Performer. In step 66 the Performer accepts responsibility for performing the task as proposed. The process then proceeds to step 68, in which the Performer works on performance of the task. In step 70 the Initiator is informed that the Performer is working on the task, by forwarding a message to the Initiator, by changing a status regarding the task on a task management window for the Initiator, or by a combination of the above. In step 72 the Performer notes that the task has been completed by an entry into the system. In step 74 the system informs the Initiator that the task has been completed. In step 76 the Initiator closes the task. In step 78 the system informs the Performer if the Initiator has not read the read or closed the completed task, and then the process will return to step 76 to wait for the Initiator to begin closing the task. In step 80 the task is closed by the Initiator. The task can also be canceled in step 79 by the Initiator. The process ends in step 81.

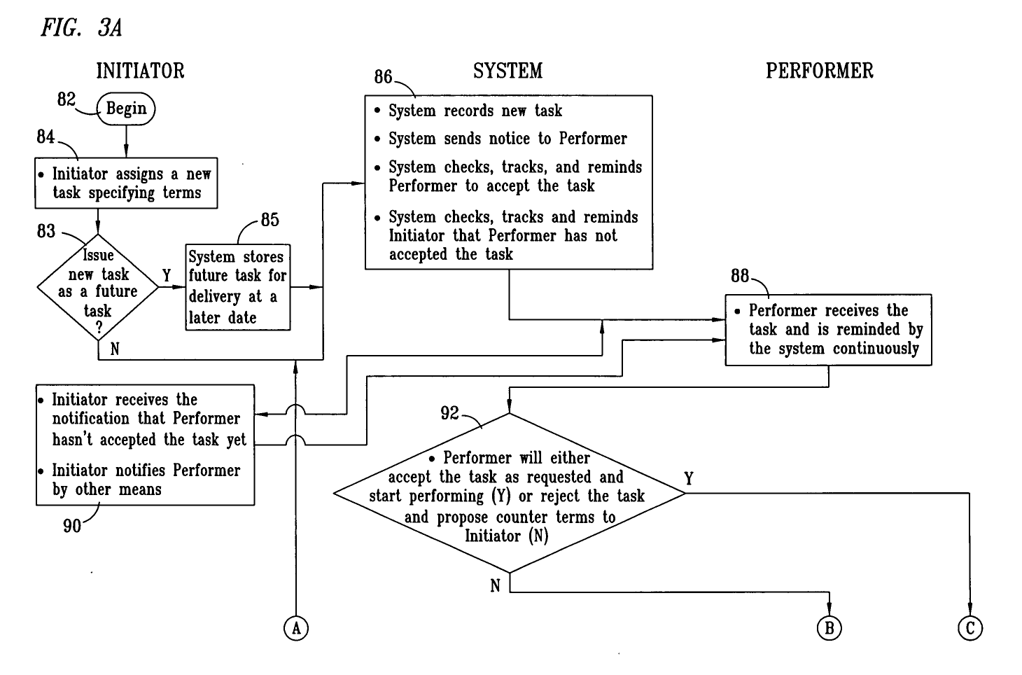

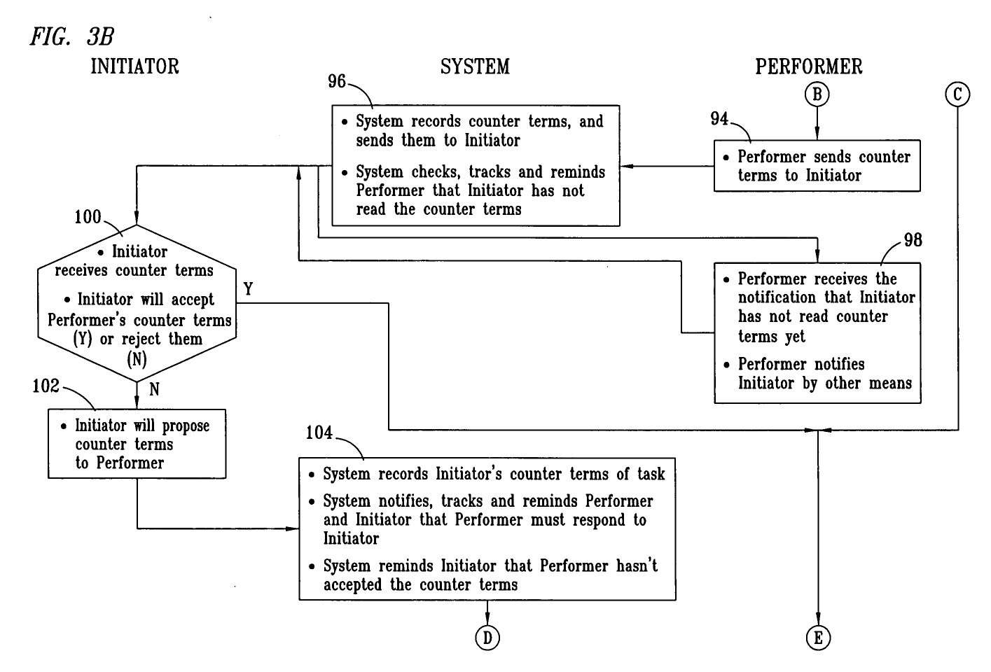

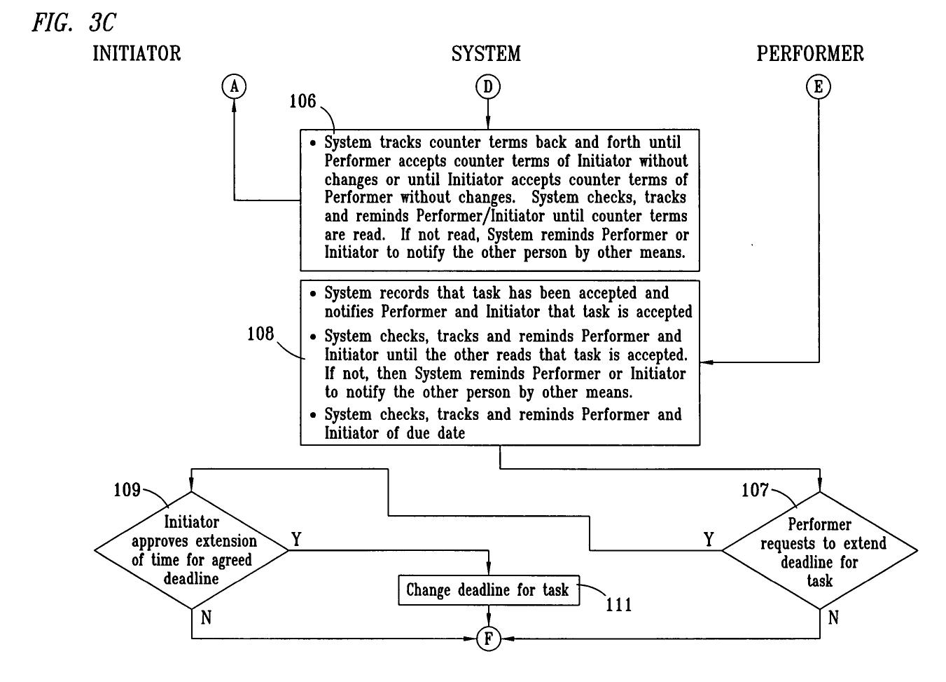

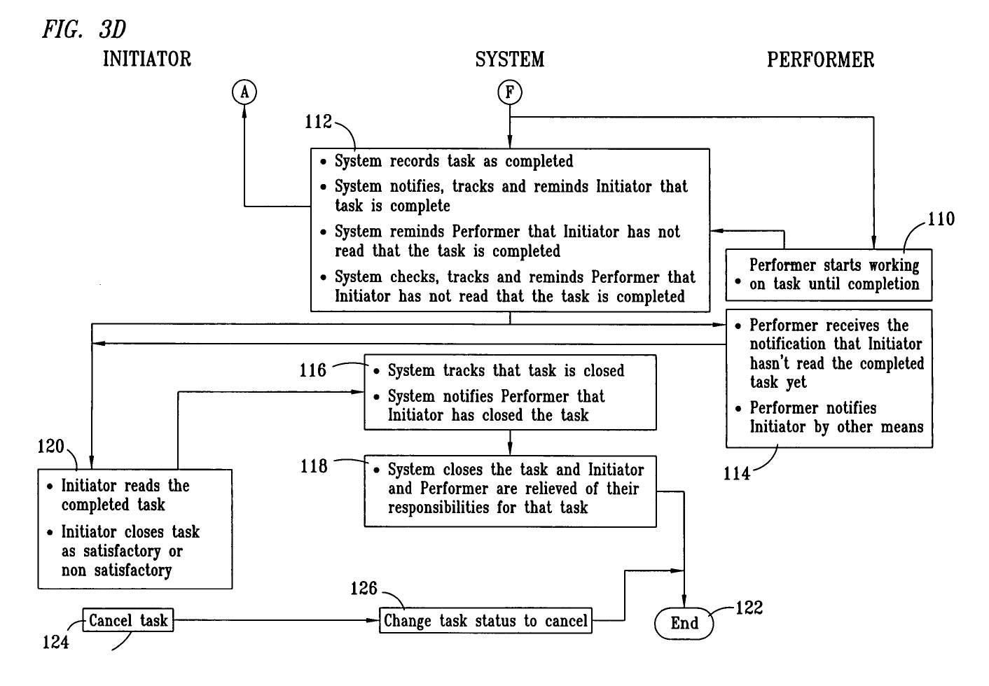

FIGS. 3A through 3D are a flow chart depicting the process of task management, which enables an Initiator to assign and track a task in accordance with an exemplary embodiment of the present invention. In step 82 the process for managing task is initiated. In step 84 an Initiator assigns a new task and specifies the terms, or parameters, for the task. In step 83, the Initiator determines whether the task is a future task, and if so, the process proceeds to step 85 and the task is stored for delivery to the Performer's task monitor at a later date. If the task is not a future task, it will proceed directly from decision step 83 to step 86. In step 86 the system is used to record the new task, to send notice to a Performer, to check, track and remind the Performer to accept the task, and to remind the Initiator to follow-up if a Performer has not accepted the task. In step 88 the Performer is notified of the task and continuously reminded of the task until the Performer addresses the request for task negotiation and acceptance. If the Performer does not timely address negotiation and acceptance of the task, the process then proceeds to step 90. In step 90 the Initiator is notified of the Performer's inactivity with regard to negotiation and acceptance of the task, and the Initiator can then notify the Performer of the task by other means, such as an e-mail, a telephone conference or a face-to-face meeting between the Initiator and the Performer. In step 92 the Performer reviews the task and determines whether to accept the task as defined and later begin performance of the task, or to reject the task as defined and negotiate counter terms for the task until acceptance of the task.

If the Performer determines to negotiate for different parameters for the task, such as a later completion time, a different amount of time allocated to the task than specified by the Initiator, or changes in various other parameters of the task, the process proceeds to step 94. In step 94 the Performer proposes counter terms to the Initiator. In step 96 the system records the Performer's proposed counter terms, notifies the Initiator of the proposed counter terms, tracks the Initiators response to the proposed counter terms, and reminds the Performer of the pending counter terms for the task if the Initiator does not address the proposed counter terms in a suitable time interval. In step 98 the system notifies the Performer that the Initiator has not read the counter terms, such that the Performer can notify the Initiator by other means, such as e-mail, a telephone conference or an in-person meeting between the proposed Performer and the Initiator of the task. In step 100 the Initiator receives the Performer's proposed counter terms, and the Initiator determines whether to accept the Performer's proposed counter terms or to reject the proposed counter terms. If the Initiator accepts the Performer's proposed counter terms, the process then proceeds to step 102, in which the Initiator proposes counter terms the Performer's proposed terms, with the Initiator either proposing new terms or continuing to seek acceptance of the original terms previously proposed for the requested task. In step 104 the system records the Initiator's counter terms for the requested task and tracks whether the Performer responds to the Initiator's terms proposed in step 102. In step 104 the system notifies and reminds the Performer and the Initiator that the Performer must respond to the Initiator, with continued notification to remind both the Performer and the Initiator of the pending proposed terms for the task and the status of whether the Performer has addressed the pending task request. In step 106 the system tracks the various proposals of counter terms for task parameters and whether proposed counter terms are accepted or rejected by the Initiator and Performer until either of the Initiator or Performer accepts then pending, proposed task counter terms without proposed changes, or proposed counter terms. In step 106 the system also checks, tracks and reminds the Initiator and the Performer of pending counter terms for the subject task until the proposed counter terms are read by the respective Initiator or Performer. Reminders of non-activity regarding proposed counter terms for tasks provide the other party opportunity to contact the non-responsive party by other means, such as e-mail, teleconference, or an in-person conference. The negotiation process continues until the parameters of a task are accepted by the non-proposing party, and then the process proceeds to step 108.

In step 108 the system records that the task has been accepted according to the then proposed terms, and notifies the Performer and the Initiator that the parameters of the task have been accepted by both parties. In step 108 the system checks, tracks and reminds a Performer and an Initiator of inactivity of the other party until the other party reads that the task is accepted, providing the accepting party a reminder to notify the other party by other means, as described above. In step 108 the system also checks, tracks and reminds the Performer and the Initiator of the pending task, and the due date for performance of the task. In step 107 the Performer requests more time for completion of the task, after the terms of the task have been accepted by both the Initiator and the Performer, such as which can typically occur at some later date after the original acceptance of task parameters in step 106. In step 109 the Initiator determines whether to approve or reject the Performer's request for more time. If the request for more time is rejected, the process proceeds to step 110, in which the Performer works on the task. If the request for more time is accepted, the process proceeds from decision step 109 to step 111 of changing the agreed deadline for the task, and then to step 110. In step 110 the Performer works to complete the assigned task.

In step 112 the system records the input from the Performer indicating that the task has been completed, and notifies the Initiator of completion of the task. In step 112 the system also tracks the process to determine whether the Initiator has read the notice indicating that the task has been completed and whether the Initiator has closed the task. Until the Initiator reads the notice indicating that the task has been completed and closes the task, the system will remind the Initiator that the task is complete and is waiting for closure. The system also reminds the Performer that the Initiator has not read the notice of the completed task and has not closed the task until the Initiator closes the task. In step 114 the Performer receives notice that the Initiator has not read the completed task, and then the Performer can notify the Initiator of the completed task by other means. In step 120 the Initiator reads the notice that the task has been completed, and then closes the task with comments regarding whether the task has been completed in a manner which is satisfactory or unsatisfactory to the Initiator. In step 116 the system tracks that the task has been closed by the Initiator, and notifies the Performer that the Initiator has closed the task. In step 118 the system closes the task and removes the task listing from task monitors showing activities related to the Performer and the Initiator, relieving the Performer and the Initiator of their responsibilities for the task. The process then proceeds to the end step depicted in the step 122. In step 124 the Initiator cancels the task. The process will then proceed to the step 126, in which the system changes the task status to canceled and moves to the end step 122.

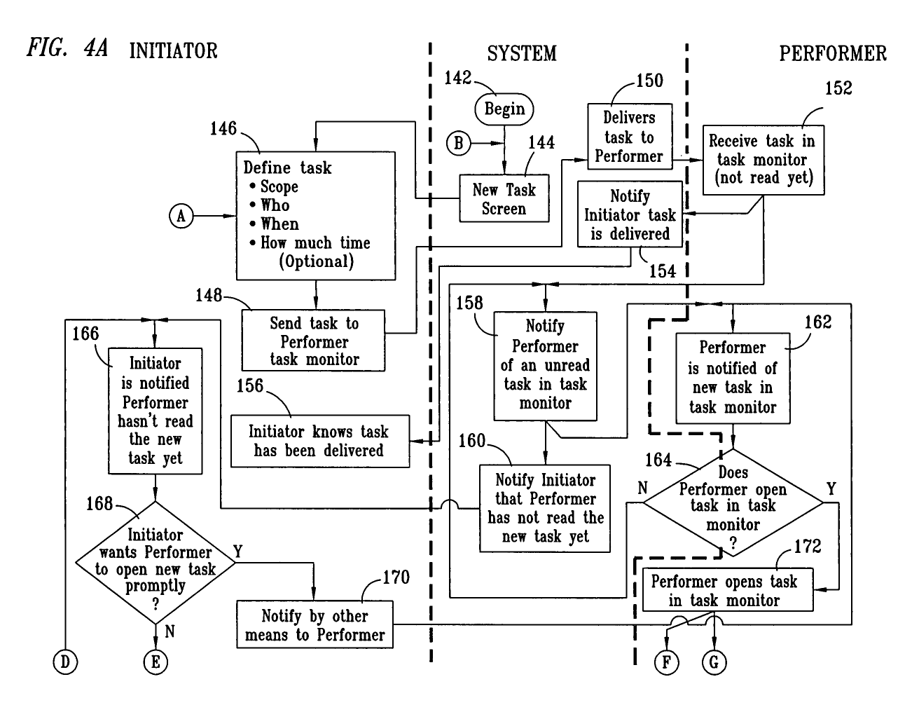

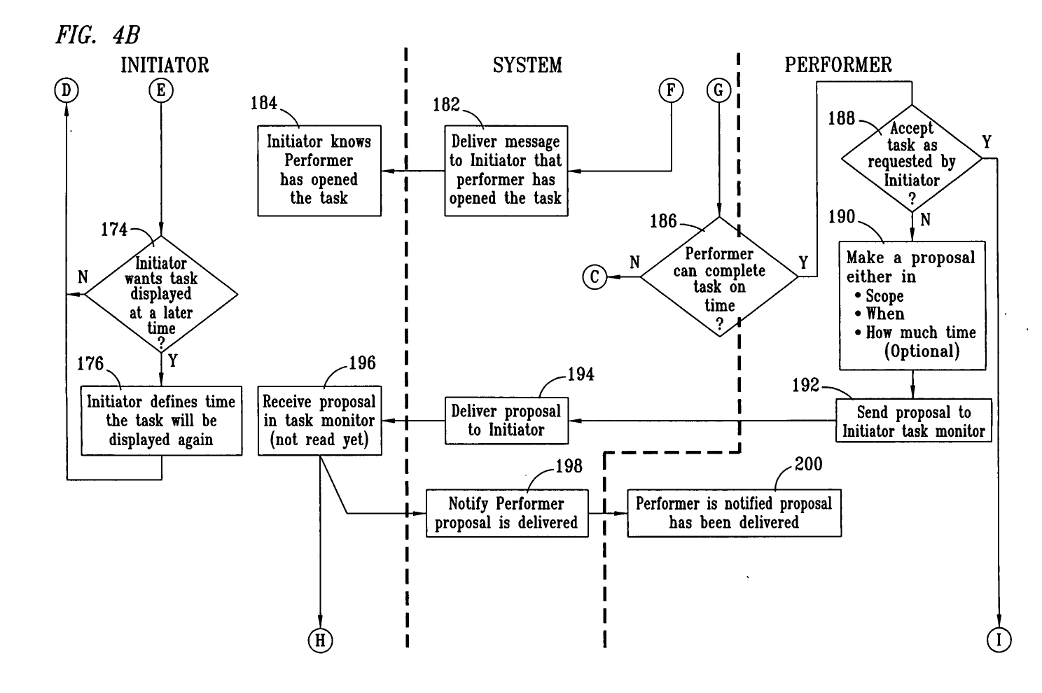

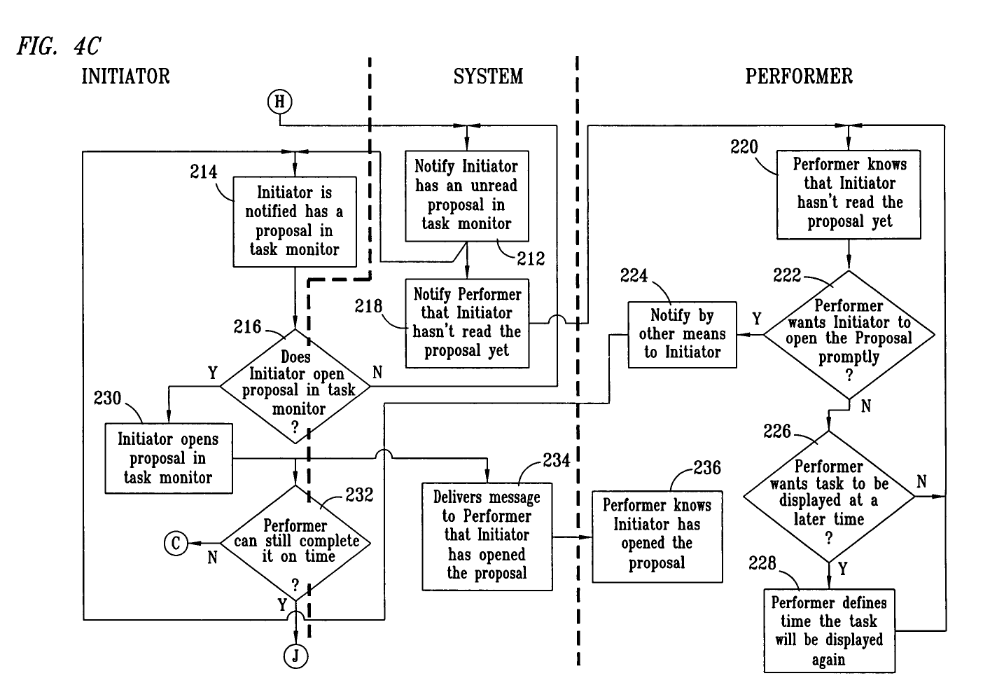

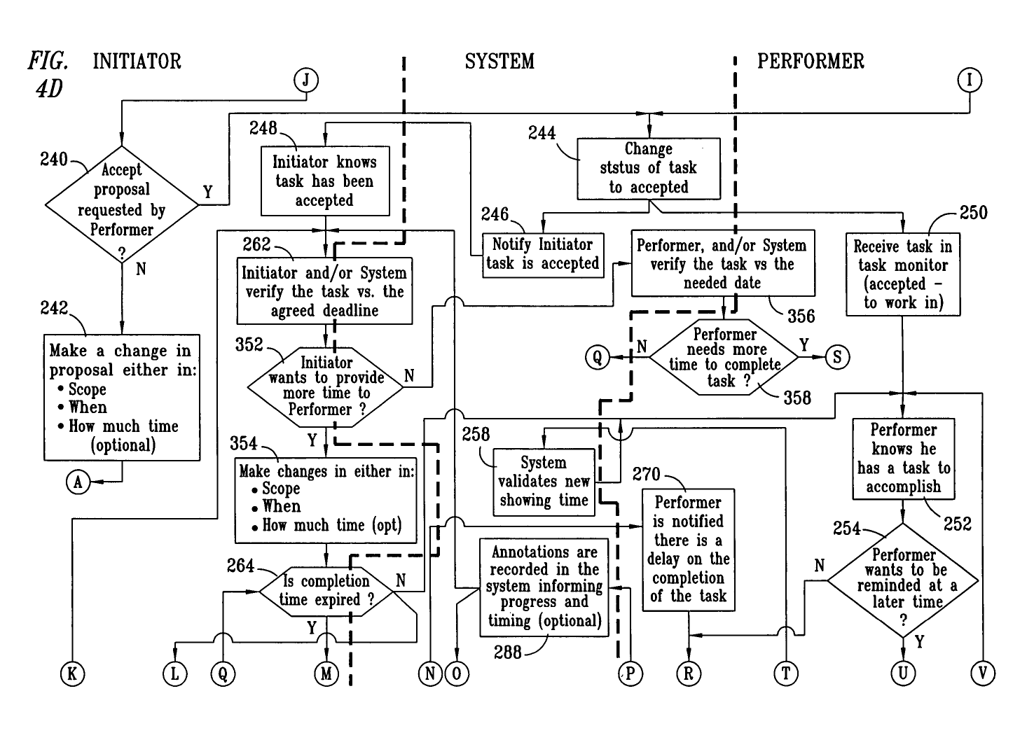

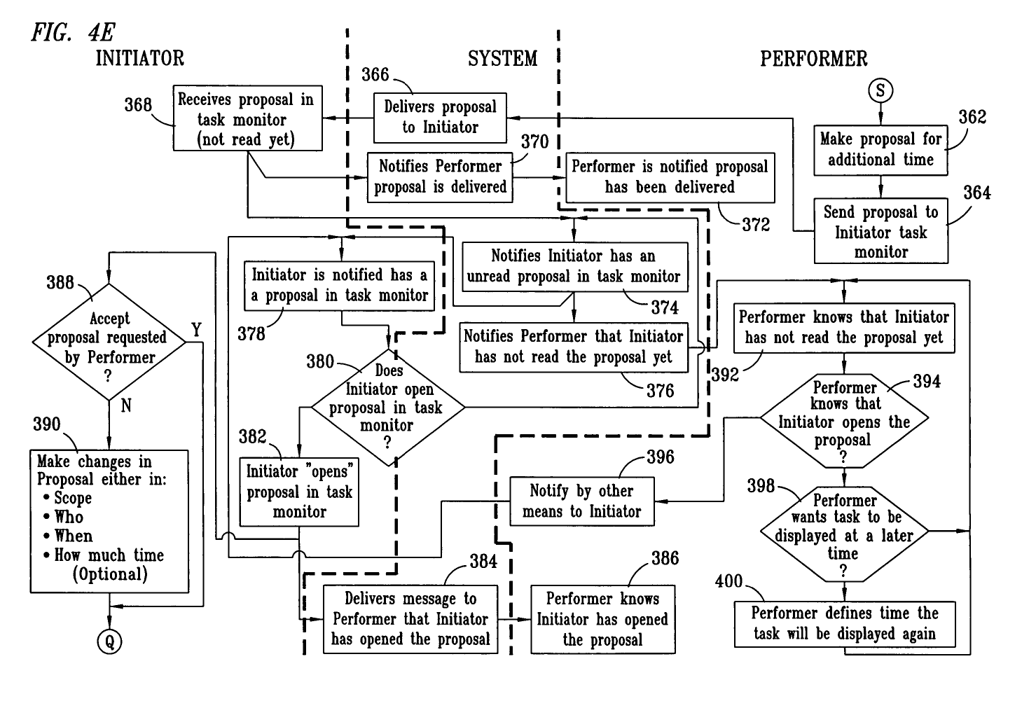

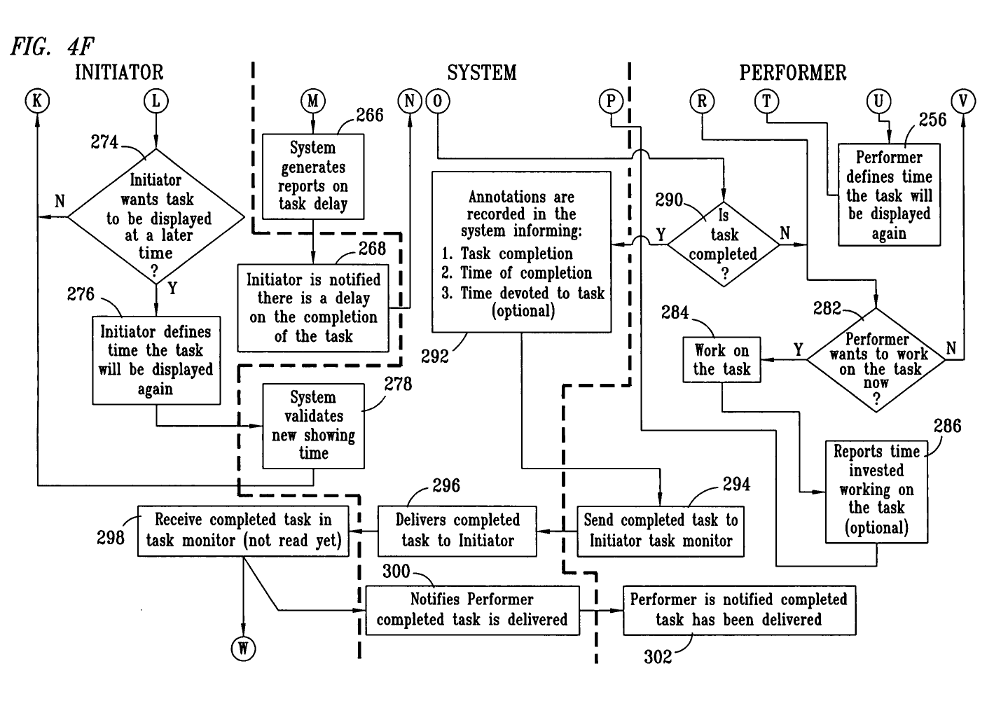

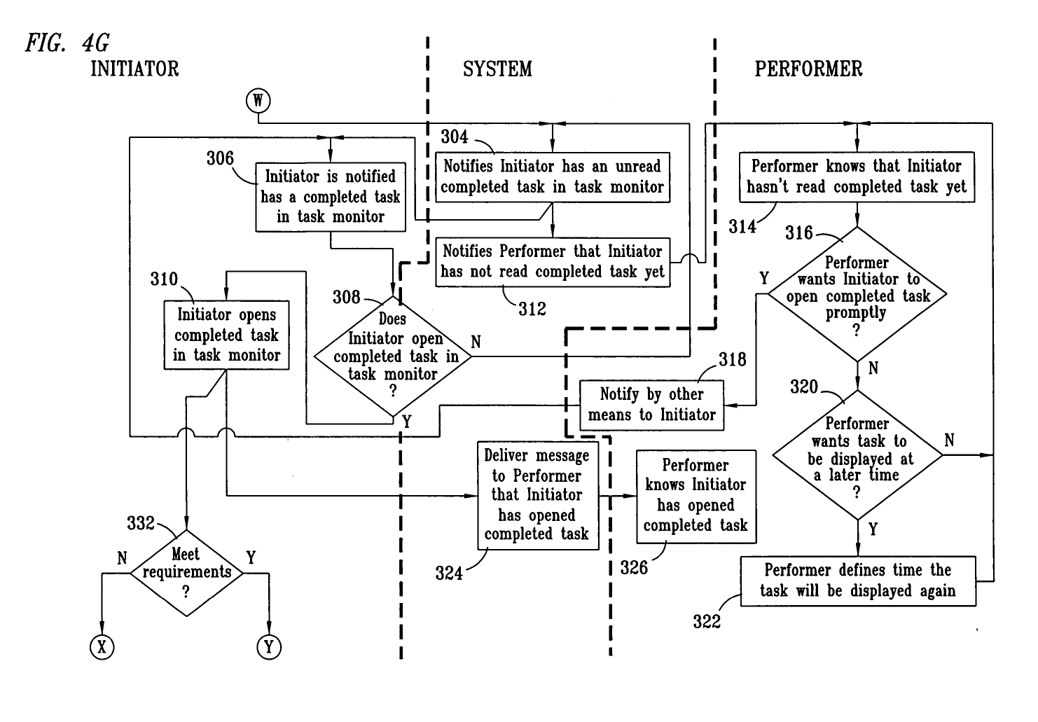

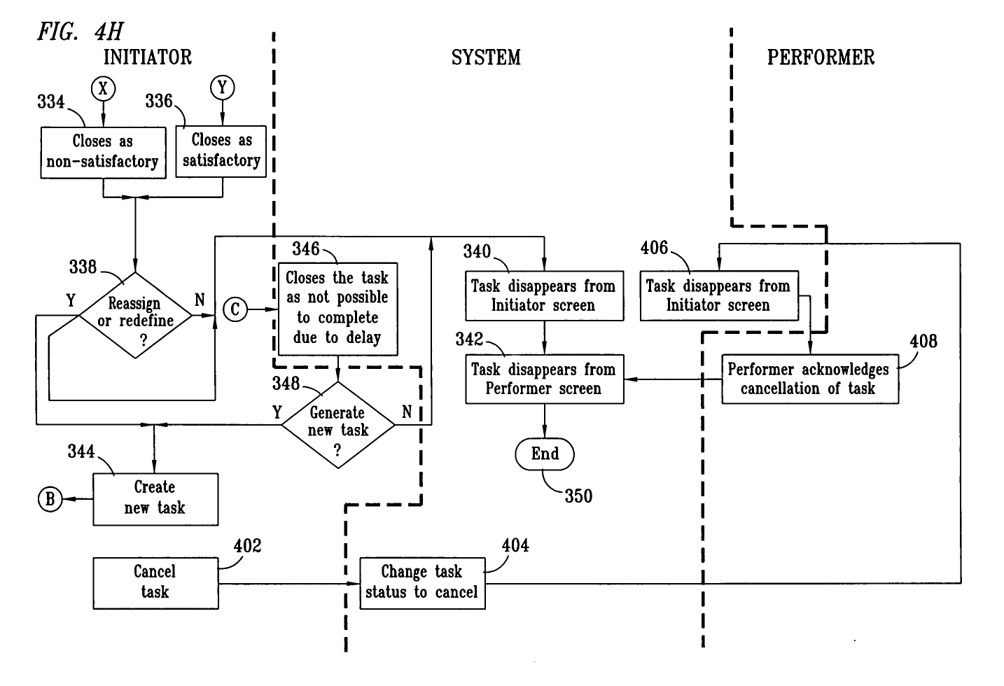

FIGS. 4A through 4H are a flow chart which depicts in more detail the process of task management, which enables an Initiator to assign and track a task to a Performer in accordance with an exemplary embodiment of the present invention. Step 142 begins the process. In step 144 the system displays a new task screen in response to a request made by the Initiator. In step 146 the Initiator defines the task by listing various parameters for the task. Preferably, the new task screen will display three main questions, and optionally a fourth question, for the Initiator to answer regarding the task. The first question is the scope of the tasks, which are the particular results desired to be achieved by performance of the task. The second question is to whom the Initiator intends to assign the task. The third second question is the desired completion date for the task. The fourth question is how much time the Performer should devote to the task. In determining the amount of time to allocate to a task, the Initiator can optionally request that the Performer determine how much time should be devoted to the task, and then the Performer can fill in the amount of time to allocate to the task. If the Initiator specifies how much time the Performer should devote to the task, in doing so, the Initiator can be communicating to the Performer the amount of detail and the degree of attention which should be devoted to the task. The Initiator can also review how much time the Performer has available during a particular time interval before assigning the task, such that the Initiator can assign the task to another individual or group, or allocate various elements of a task to different persons or groups to accomplish the entire task within a desired time interval. The task can also be a project, which is composed of various tasks, or sub-tasks, which can be assigned to different groups or different persons.

In step 148 the software sends the task parameters to the Performer's task monitor, and in step 150 the parameters of the task request are delivered to the Performer. In step 152 the software records that the task has been delivered to the Performer's task monitor, and in step 154 the system notifies the Initiator that the task request has been delivered to desired Performer's task monitor. In step 156 the Initiator's task monitor displays a notice that the task has been delivered to Performer. In step 158 the system provides notice to the Performer of an unread task request being displayed on the Performer's task monitor. In step 160 the Initiator is notified that the task request is displayed on the Performer's task monitor and that the Performer has not read the task request. In step 162 the Performer receives notice that the new task request is being displayed on the Performer's task monitor. In step 164 the system determines whether the Performer has opened the task request in the Performer's task monitor. If the system determines that the Performer has opened the new task request, the process proceeds to step 172. If in step 164 the system determines that the Performer has not opened the new task, the program proceeds back to the input of step 158 and again notifies the Performer of an unread task in the Performer's task monitor, and also proceeds back to step 160 and provides notice to the Initiator of the task not being read by the Performer. In step 166 the system provides notice to the Initiator that the Performer has not read the task request. In step 168 the Initiator determines whether he wants the Performer to promptly open the new task request, and if so, the process proceeds to step 170 and the Initiator notifies the Performer of the new task request waiting for display on the Performer's task monitor by other means, such as by a telephone call, a page, an e-mail message, a personal visit or contact with the Performer by any other available means. If in step 168 it is determined that the task request does not require immediate attention, the process proceeds to the decision step 174 and the Initiator determines whether the task can be displayed at a later time. In step 176 the Initiator preferably determines a later time when the task request will be displayed to the Performer and the Initiator as a reminder regarding the task. If in the decision step 174 it is determined that the task requires prompt or immediate attention, the process proceeds back to step 166 and step 168, such that the process proceeds to step 170 and the Initiator can inform the Performer of the pending task request by other means.

In step 172 the Performer opens the task in the task monitor and then the process automatically proceeds to step 182 and step 186. In step 182 a message is delivered to the Initiator's task monitor which indicates that the Performer has opened the task request. In step 184 the Initiator opens and reads the message, and waits for a response form the Performer regarding acceptance of the task according to the specified parameters, or a counter proposal from the Performer. In step 186 the Performer makes an initial determination of whether he can complete the task on time. In some embodiments, step 186 can also include the system determining whether the Performer can complete the requested task in the requested time, such as determining whether the requested deadline for the task has passed. In still other embodiments, in step 186 the system can also compare the expected time to complete the task and determine whether sufficient time exists for the Performer to dedicate to complete the task prior to expiration of the requested deadline, including comparing the time requirements for other tasks then presently assigned to the Performer. In the preferred embodiment, the Performer will make such a determination regarding the amount of time the Performer has available to devote to the task and the accuracy of the Initiator's estimation of the time required to satisfactorily complete the task. If a determination is made in step 186 that the Performer does not have adequate time to complete the task according to the parameters specified by the Initiator, the process will proceed to step 346 in FIG. 4G, and proceed to close the task as not possible to complete in the specified time allocated for the task. In some embodiments of the present invention, a pop-up message could alert the Initiator during the phase in which task parameters are specified in step 146, that the Performer does not have sufficient time or resources to complete the task according to the specified parameters. If instead a determination is made that the Performer has sufficient time to satisfactorily complete the task, the process proceeds to step 188 and the Performer makes a further determination of whether to accept the task as proposed by the Initiator, or whether to make a counter proposal which modifies the proposed task. The Performer preferably analyzes the task as requested according to the specified parameters. The Performer reads the task request and attached documentation, if any. The Performer should preferably decide either to accept the task based on the scope and due date, or to reject the task and make a counter proposal which modifies the parameters of the task to those the Performer finds acceptable. The Performer preferably should submit a counter proposal which modifies the parameters of the task rather than fully rejecting the task. If the Initiator specified a time to devote to completing the task, the Performer can evaluate what the originator has in mind regarding time allocated for the task according to the scope of the task set forth in the Initiator's original task request, and manually compare the Performer's available time against the time estimated to complete the task. Preferably, the system will maintain a meter of the available time remaining for the Performer and compare the Performer's available time against the time the Initiator allocated for performance of the task. If the Performer accepts the task according to the initial parameters specified by the Initiator, the process proceeds to step 244, in which the status of the task is changed to Accepted in the system.

If instead the Performer determines to reject the task, and to not accept the task as set forth according to the parameters specified by the Initiator, the process proceeds to step 190 for the Performer to make a counter proposal to change the scope, due date, or amount of time allocated for performance of the task, and other parameters specified in the Initiator's original task request. If the Performer does not accept the task as proposed by the Initiator, the process proceeds to step 190 and makes a counter proposal, proposing a change in parameters of the task, such as the scope, due date, or amount of time allocated for performance of the task, and other task parameters. The negotiation process continues until both the Initiator and the Performer agree on the details of the parameters for the task, or the Initiator decides to cancel the task request for that particular Performer. A proposal preferably includes at least one of the following: a change in the date and/or time to complete the task, a change in how much time to spend on task, or a note that additional information about the task is needed. The Performer makes the proposal on the existing task request and then forwards the new proposal to the Initiator in step 192. If changes to the parameters of the task are proposed in step 190, the proposal is then forwarded to the task monitor of the Initiator in step 192 and delivered to the Initiator in step 194. If in step 188 the Performer accepts the task as requested by the Initiator, the process will proceed to step 244 and the status of the task is changed to accept.

In step 196 the Performer's proposal is received in the Initiator's task monitor, prior to the Initiator reading the Performer's proposal. The occurrence of step 196 triggers two steps, step 198 in which the Performer is automatically notified that the proposal has been delivered to the Initiator's task monitor and step 212 in which the system notifies the Initiator of an unread proposal waiting in the Initiator's task monitor. Occurrence of step 212 triggers two additional steps, step 214 in which the Initiator is notified of the unread proposal in the Initiator's task monitor and step 218 in which the system automatically notifies the Performer that the Initiator has not yet read the proposal. In step 216 the system determines whether the Initiator has opened the proposal. If the system determines that the Initiator has opened the proposal, the process proceeds to step 230. If the Initiator has not yet opened the new proposal, the process will proceed back to step 212 to notify the Initiator of an unread proposal in the Initiator's task monitor and then in step 218 the Performer is notified that the Initiator has not yet read the proposal. In step 200 the Performer receives the notice regarding the task request being delivered to the Initiator's task monitor. In step 212 the Initiator is notified that an unread task proposal is in the Initiator's task monitor, and in step 214 the Initiator actually receives the notice of the unread task request. In step 216 the Initiator determines whether to open the task request forwarding the Performer's proposal after the Initiator is notified of the message in step 214. If the Initiator does not open the message containing the Performer's proposal in step 216, the process proceeds back to step 212 and again notifies the Initiator of the unopened task in the Initiator's task monitor, and then proceeds to step 218. In step 218 a message is sent to notifying the Performer that the Initiator has not read the task request from the Performer containing the proposal, if the task request has not been opened after a selected period of time.

In step 220 the Performer receives the notice that the Initiator has not read the counter proposal. In step 222 the Performer determines whether to notify the Initiator to open the Performer's task proposal by other means. If the Performer determines in step 222 to notify the Initiator to open the proposal, the process proceeds to step 224, and the Initiator is notified of the unopened proposal by other means, as discussed above. If in step 222 the Performer determines that Initiator does not need to immediately review the proposal, the process proceeds to the decision step 226, in which the Performer determines whether a reminder for the task should be displayed for the Initiator at some later time, and if so, the later display time is selected by the Performer in step 228. The process then proceeds back to step 220, and the Performer is notified that the Initiator has not read the Performer's proposal. In step 230 the Initiator opens the proposal in the Initiator's task monitor, which triggers step 234, in which a notice is delivered to the Performer to indicate that the Initiator has opened the task request containing the Performer's counter proposal. In step 236 the Performer receives the notice generates in step 23 and then knows that the Initiator has opened the Performer's proposal. The process will also proceed to step 232 to evaluate whether the Performer can complete the task on time, and then to step 240, in which the Initiator determines to either accept or reject the Performer's counter proposal. In step 232 a determination is made by the Initiator whether the Performer can complete the task by the Initiators required deadline. If it is determined that the Performer can complete the task, the process proceeds to step 240. If the due date has expired before the Performer accepts the task, the system will not allow the Initiator to proceed. If the task can not be completed by the required due date, the system will proceed to step 346.

In step 240 the Initiator reviews the Performer's counter proposal and determines whether to accept the proposal. The Initiator will preferably make a determination of whether to accept or reject the proposal in step 240. If the Initiator rejects the proposal in step 240, the Initiator should make a counter proposal and submit the new proposal to the Performer in step 242, preferably proposing different terms to the Performer by making a new counter proposal. In making a new counter proposal the Initiator will add changes in when the task is due, can optionally propose how much time to spend on the task, the scope of the task, or a combination of the above. Once the Initiator has entered the relevant information for the new counter proposal, the Initiator will forward the new counter proposal to the Performer. The negotiation process can be continued with the process returning to step 146, in which the Initiator defines the task parameters for forwarding to the Performer as part of making the new counter proposal for the task request. If the Initiator accepts the Performer's proposal, the Performer is then bound to the terms of the accepted proposal and is obligated complete the task based on the time requirements of the proposal. The process will then proceed from step 240 to step 244, in which the task status is changed to Accepted. The counter proposal is a continuation of the original task request where the life cycle of a task is visible and recorded throughout the process. Changing the status of the task to Accepted in step 244 automatically triggers two steps, step 246 and step 250. In step 246 the system sends notification to the Initiator that the task has been accepted. In step 250 the task is added to the Performer's Task Monitor, which is similar to an e-mail inbox, or work inbox, and shows as having a status of Accepted. In step 250 the Performer accepts the task with all the terms and conditions placed on it, and by this, Performer becomes accountable for the task. If the task arrived to this Performer by way of step 240 to step 244, then in step 250 the Performer is notified that the Initiator has accepted his proposal.

From step 246 the process will proceed to step 248, in which the Initiator receives and then reviews the notification and knows the task has been accepted. The process then proceeds to step 262. In step 262 the Initiator and/or the system verifies that the task date against the agreed deadline. In step 352 the Initiator makes a determination of whether to grant more time to the Performer. If the Initiator determines to grant the Performer more time to complete the task, the process proceeds to step 354 and the Initiator makes changes in either the scope, the due date, and, optionally, the amount of time allocated to complete the task. If in step 352 the Initiator determines to not provide more time to the Performer, the process proceeds to step 356 and the Performer and the system verify the task parameters against the date on which completion of the task is required. If in step 356 a determination is made that the Performer does not require more time to complete the task, the process proceeds to step 264 and a determination is made of whether the completion time has expired. If in step 358 a determination is made that the Performer requires more time to complete the task, the process proceeds to step 362 in which the Performer makes a proposal for additional time to complete the task. In step 364 the proposal for additional time is forwarded to the Initiator for display in the Initiator's task monitor. The system delivers the proposal for additional time to the Initiator in step 366, and the task is received in the Initiator's task monitor in step 368. In step 370 the system notifies the Performer that the task has been delivered to the Initiator, and the Performer receives the notification in step 372. The system notifies the Initiator that an unread proposal has been delivered to the Initiator's task monitor in step 374. The system will also notify the Performer that the Initiator has not read the proposal in step 376. In step 378 the Initiator receives notice of the unread proposal being in the Initiator's task monitor.

The Initiator then determines whether to open the new proposal in step 380. If the Initiator determines to open the proposal at that time, the process proceeds to step 382 in which the Initiator opens the proposal. When the Initiator opens the proposal, the system in step 384 delivers a message to the Performer to indicate that the Performer's proposal has been opened by the Initiator, and in step 386 the Performer reviews the message regarding the Initiator opening the proposal. After the Initiator opens the proposal in step 382, the system will also proceed to step 388 in which the Initiator determines whether to accept the proposed changes to the task submitted by the Performer. If the Initiator does not accepts the Performer's proposed changes, the process proceeds to step 390 and Initiator can propose other changes to the task parameters, and then the process will proceed to step 264 in which a determination is made of whether the completion time has expired for the task. If the Initiator determines to accept the Proposer's changes in step 388, the process will then proceed to step 264 for a determination of whether the completion time has expired for the task.

If in step 380 the Initiator determines to not open the proposal in the task monitor, the process proceeds back to step 374 in which and the Initiator is notified of the unread proposal in the Initiator's task monitor and the Performer is notified that the Initiator has not read the proposal in step 376. Notification of an unread task can be displayed by the system placing a flag on the task monitors of the Performer and the Initiator. Such a flag can be provided by highlighting the task in a color which is different from others displayed in the task monitor, or placing an easily viewed and easily recognized iconic symbol displayed next to the task. In step 392 the Performer receives the notice regarding the Initiator not having read the proposal. In step 394 the Performer determines whether the Initiator should open the proposal at that time. If the Performer wants the Initiator to open the proposal at that time, the process proceeds to step 396 and the Performer notifies the Initiator by other means, such as by e-mail, telephone, page, personal visit, and the like. If the Performer determines that the Initiator can open the task at a later time in step 394, the process proceeds to step 398 in which the Performer determines whether to display the task at a later time. If the Performer determines to open the task at a later time, the process proceeds to step 400 in which the Performer defines the later time at which the task will be displayed, and then the process proceeds back step 392 at the selected later time. If in step 398 the Performer does not specify that the task be displayed at a later time, the process will return to step 392 to remind the Performer that the Initiator has not read the proposal.

In step 264 a determination is made of whether the time in which the task was to be completed has expired. If the due date has passed, the process proceeds to step 266, in which the system generates a report of task delays. If the due date has not passed, the process proceeds to both steps 252 and 274. In step 274 the Initiator determines if he would like for the task to be displayed at a later time. If not, the process returns to step 262. If the Initiator would like the task to be displayed at later time, the process will proceed to step 276, in which the Initiator defines a date and time for the system to remind the Initiator of the open task. The process then proceeds to step 278, in which the system validates and registers the new date and time at which to display the task to the Initiator. The system is now set to send a notification to the Initiators task monitor at the time requested in step 276. The process then returns to step 262.

In step 252 the Performer knows that he has a task to accomplish. Beginning at this point in time, the Performer has full responsibility until the task is returned to the Initiator as having been completed. Since both parties freely accepted the terms of the task, this process is similar in concept as having a signed contract between Initiator and Performer for the conclusion of a task. In step 254 of the Performer determines whether the system will forward a reminder to the Performer for the accepted task. If the Performer chooses not to set a reminder, the process advances to step 282 and the Performer evaluates whether he wants begin working on the task. If the Performer chooses to set a reminder, the process moves to step 256. In step 256 the Performer defines a later point in time when the system should remind him to check on the open task. After entering the time which the task should be displayed again, the process advances to step 258. In step 258 the system validates and registers the new time for displaying the task to remind the Performer of the pending task. The system is now set to send a notification to the Performer's task monitor at the date and time requested in step 256. The process then proceeds to step 252. In step 282 the Performer must decide whether he is ready to begin working on the task. If not, the Performer remains aware of the task as he proceeds back to step 252. If the Performer decides to begin working on the task, he proceeds to step 284 and works on the task.

In step 286 the Performer, as an option, can log the time spent working on the task and notations about the progress of the work. From the optional step 286, the process proceeds to the optional step 288 and the system records annotations as to the time spent and progress made on the task. As the task is being worked on the system proceeds to step 262 and verifies the current date and the current time against the date and the time on which the task is due. The process also proceeds to step 290 and makes a determination of whether the task has been marked as completed by the Performer. If the task has gone past the estimated completion time without being completed, in step 266 the system generates a report on the task because it has exceeded the requested time for completion. The process then proceeds to step 268, in which the Initiator is notified that the task is delayed beyond the assigned completion date. In step 270 the Initiator notifies the Performer that the task is still outstanding and the due date has expired. The Performer determines if the task should be worked on by proceeding to step 282, and making a determination of whether to proceed to step 284 and work on the task, or whether to proceed to step 252 and step 254, and request a reminder to later work on the task.

In step 290 the Performer determines whether the task has been completed. If the Performer determines that the task is not yet complete, the process will proceed to step 282 to determine whether the Performer should continue working on the task. Once the task is completed, the Performer marks the task complete in the system, which then sends the open, but completed task back to the Initiator. In step 292 the Performer enters annotations into the system and optionally attaches documentation regarding the task. The information recorded is preferably the status of the task as having been completed, the time of completion and, optionally, the amount of time devoted to the task. Then in step 294 the system sends the completed task to the Initiator so that the Initiator can rate the performance of the Performer in completing the task and close the task, and the completed task is delivered to the Initiator's task monitor in step 296. The Performer is responsible for the task from step 244 in which the status of the task is changed to accepted, through step 290 and step 292, in which the Performer changes the status of the task to completed, and up until the Initiator opens the completed task in step 310.

In step 296 the system delivers the completed task to the Initiator's task monitor. In step 298 the completed task has been delivered to the Initiator's task monitor but has not been read by the Initiator. Step 298 triggers two steps, with the process simultaneously proceeding to step 300 and to step 304. In step 300 the system automatically places a notice in the Performer's task monitor that the completed task has been delivered to the Initiator's task monitor, and in step 302 the Performer reviews the notice regarding the completed task having been delivered to the Initiator. In step 304 the system notifies the Initiator that he has an unread completed task in his task monitor. This process triggers two additional steps, step 312 and step 306. In step 312 the Performer is notified that the Initiator has not read the completed task. In step 306 the Initiator is notified that he has a completed task in the task monitor. In step 308 the system determines whether the Initiator has opened the completed task. When the Initiator opens the completed task, the process proceeds to step 310. If the Initiator does not open the completed task, the process proceeds back to step 304. In step 314 the Performer receives the notification and knows that the Initiator has not read the completed task. In step 316 the Performer decides whether he would like for the Initiator to promptly open the completed task. If the Performer wants to contact the Initiator immediately, the process proceeds to step 318 and the Performer contacts the Initiator by other means, such as by telephone, page, e-mail, personal visit, or the like, and then the process proceeds to step 306. If in step 316 the Performer elects to not contact the Initiator immediately by other means, the process proceeds to step 320 and the Performer determines whether he wants to be reminded about this open task at a later time. If the Performer selects to not have a later reminder, the process returns to step 314. If the Performer selects a reminder, the process proceeds to step 322. In step 322 the Performer defines the time at which the system will display the notification to the Performer regarding the fact that the Initiator has not opened the completed task. The process then proceeds back to step 314.

In step 310 the Initiator opens the completed task in his task monitor, which automatically triggers step 324. In step 324 the system sends a notification to the Performer that the Initiator has opened the completed task, and in step 326 the Performer receives such notification. In step 310 the Initiator reads the task completion annotations made by the Performer and any attached or referenced documentation. Next, the Initiator proceeds to step 332 and determines whether the completed task met the parameters of the task. The Initiator cannot reject the completed status for the task, but depending on the results of the task, the Initiator can apply a rating for the completed task as satisfactory or unsatisfactory, depending upon whether the Performer adequately met the agreed parameters for the task. If the Initiator rates the completed task as satisfactory, the process proceeds to step 336 and the task is closed with a satisfactory status. If the Initiator rates the task completion as unsatisfactory, the process then proceeds to step 334 and the task is closed with an unsatisfactory status. For tasks closed with an unsatisfactory status, the Initiator will enter a note to document why the task was rated as not being satisfactorily completed. This information can be used for auditing and evaluation purposes. The process will then proceed to step 338, in which the Initiator determines whether to reassign or redefine the task by generating a new task. The Initiator has the option to re-define and reassign the task, as a new task in step 344. However, the completed task which is being closed preferably does not remain open, but rather a new task is opened if the Initiator determines that matters relating to the task which is being closed require further attention. If the task was completed as originally defined, the Initiator will close the task as satisfactory. The Initiator is not required to enter notes about tasks which are being closed as having been performed satisfactorily. If the Initiator re-assigns the task, the process proceeds to step 344. If not, the process proceeds to step 340.

In step 346 the system closes tasks which are not able to be completed within the requested due dates due to the task expiring before being accepted. The only tasks which would encounter step 346 would do so by route of step 186 and step 232. The tasks which are processed in step 346 are those which are past due before being accepted. These are different than the tasks that have been accepted yet simply expired. If a task has been accepted and expired, the system does not close it but only sends a notification to the Initiator as shown is step 266. In step 348 the Initiator determines whether to create a new task. If the Initiator chooses not to create a new task, the process proceeds to step 340. If a new task is created, the process proceeds to step 344, which returns the process back to step 144. The new task can be linked to the just completed task. In step 340 the system removes the task from the Initiator's task monitor. The process then proceeds to step 342. In step 342 the system removes the task from the Performer's task monitor. The closed tasks remains in the system database for future auditing purposes.

Optionally, the Initiator can determine to cancel a task prior to completion, and if so, can proceed with step 402. In step 404 the system changes the task status to cancelled. In step 406 the system removes the task from the Initiator's task monitor screen. The Performer will then acknowledge the cancelled task in step 408, and the process will proceed to step 342 in which the system removes the cancelled task from being displayed on the Performer's task monitor screen. The process will then end in step 350.

It should also be noted, that for tracking purposes, a person can assign a task to himself, which is termed a Self Task Assignment. Then most of the steps described above will not occur as part of the Self Task Assignment, because the Initiator and the Performer are the same person. The steps for tracking accepted tasks performed by the system will still occur.

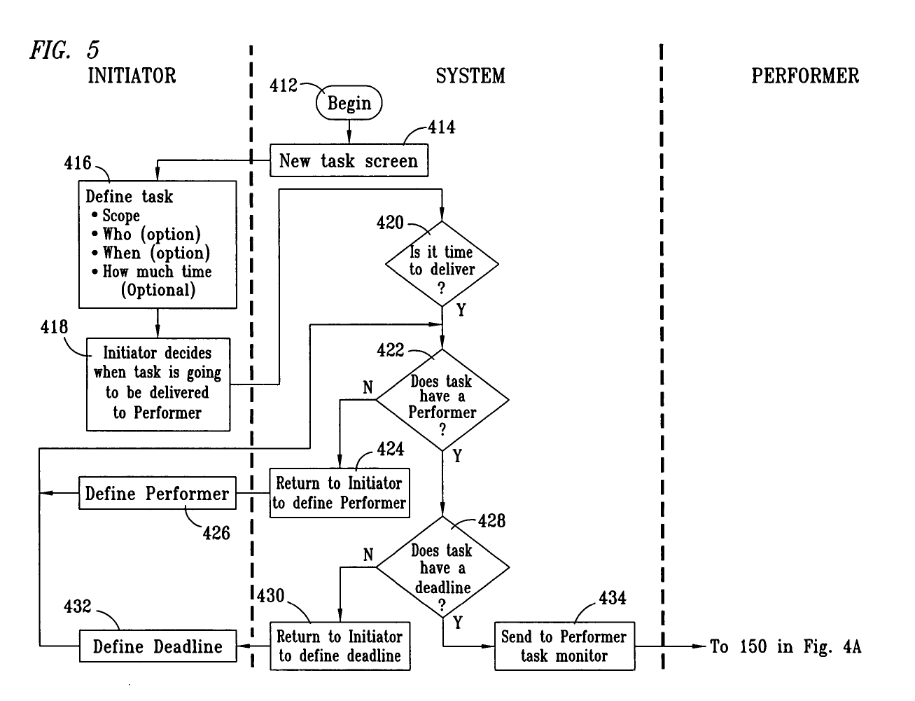

FIG. 5 is a flow chart depicting a process for defining and assigning a future task for delivery to a Performer at a later date in accordance with an exemplary embodiment of the present invention. The process begins in step 412, and a new task screen is opened in step 414. In step 416 the Initiator defines parameters for the task. In step 416 the Initiator determines to whom the task will be delivered, and can optionally choose that the task be later delivered to himself rather than assigning the task to a particular individual. The Initiator will determine when the task will be delivered to a Performer in step 418. The system will then monitor the task to determine then the designated time for delivery of the task has arrived in step 420. When the time has occurred to deliver the task as determined in step 420, the process will proceed to step 422 and determine if the task has a Performer, that is, to determine to whom the task should be delivered. If the system determines in step 422 that the task does not have a performer assigned, the process will proceed to step 426 in which the task is returned to the Initiator and the Initiator will assign the task to a Performer in step 426. Then the process will proceed back to step 422 and then to step 428, in which the system will determine whether the task has a deadline associated with it. If a deadline for the task has not been determined by the Initiator, the process will proceed to step 432 and the Initiator will define a deadline for the task. The process will then proceed from step 432, back through step 422 and step 428, and the system will send the task to the performer in step 434. From step 434 the system proceeds to step 150 in FIG. 4A, and the Performer will be notified of the unopened task in his task monitor.

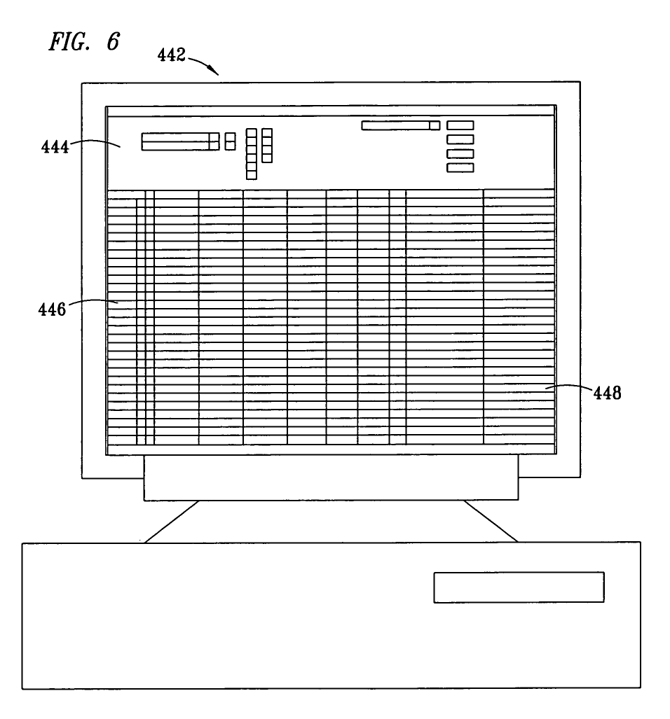

FIG. 6 is a screen shot of a computer monitor 442 of a system depicting a task monitor 444 in accordance with an exemplary embodiment of the present invention. The task monitor 444 displays a tabular listing of various tasks, with each row 446 preferably corresponding to various ones of the tasks and each column 448 representing various parameters for the corresponding ones of the tasks. The displayed parameters indicate due dates, performance guidelines relating to the particular tasks, and optionally, the amount of time to allocate to the tasks. It should also be noted that the tasks monitor 444 for a particular user can list tasks for the user as both an Initiator and a Performer for the various displayed tasks. The task listings can also be represented in various colors, or with different iconic representations to indicate tasks which have not been opened or reviewed, tasks which are due soon, tasks which are past due, and tasks which are of higher priority than others, tasks for which the user is a Performer as opposed to an Initiator, and such. The tasks can also be grouped into adjacent rows according to due dates, whether the user is as Performer or an Initiator, priority of the tasks, and the like.

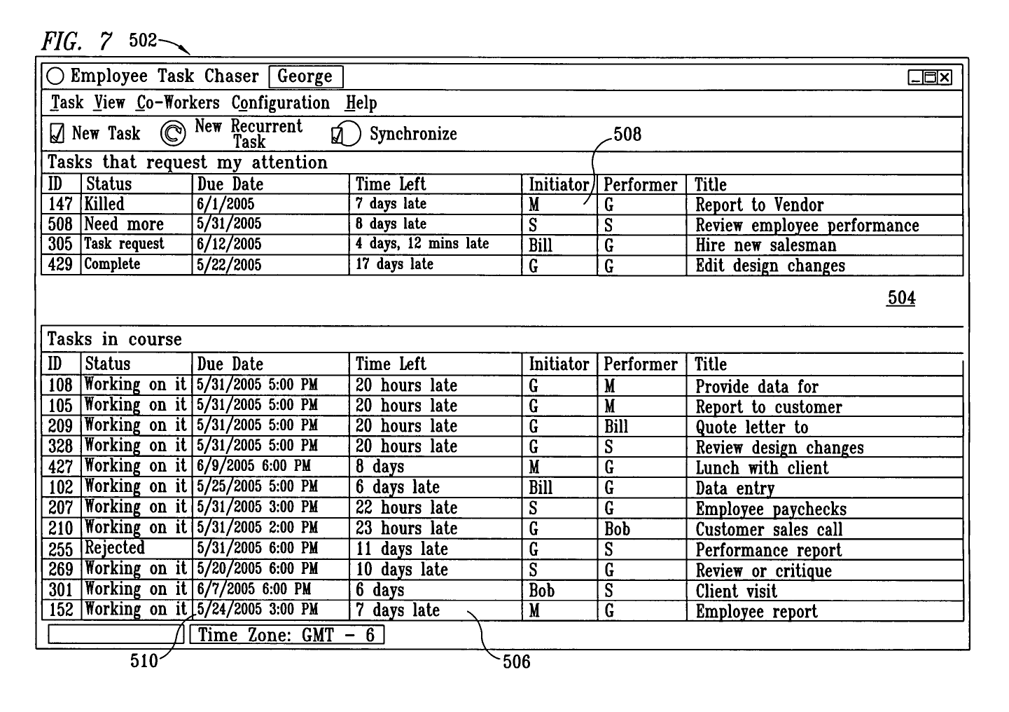

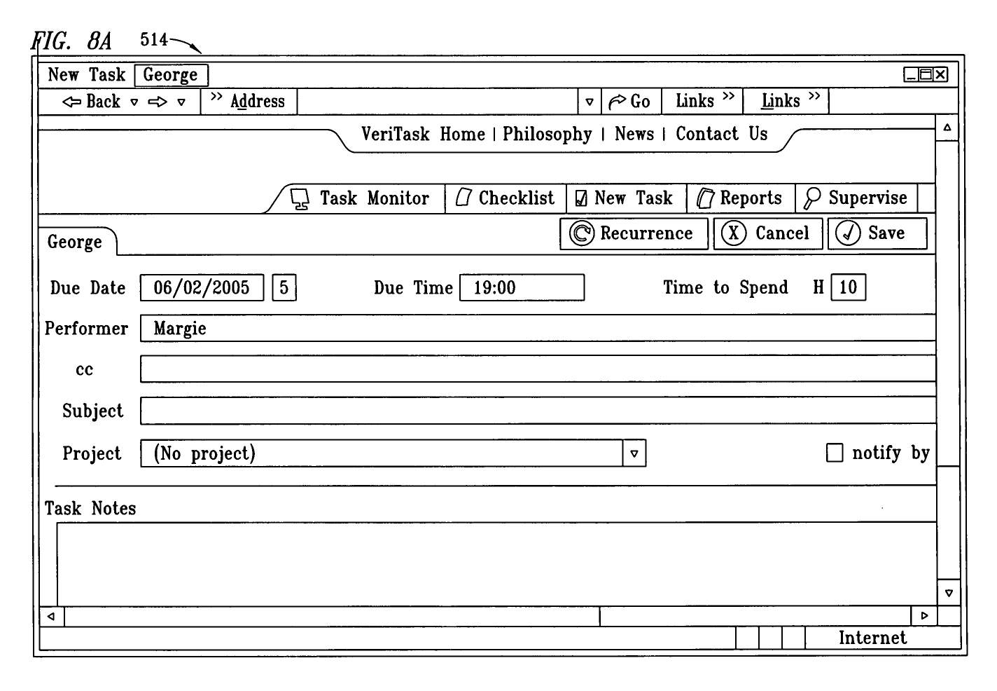

FIG. 7 is a display of a task monitor 502 and lists tasks which are the responsibility of a user, as both a Task Assignor and a Task Performer, in accordance with an exemplary embodiment of the present invention. The task monitor is split into two screens, or regions, 504 and 506. The first region 504 displaying tasks, such as task 508, requiring action form the particular user, both as a Task Assignor and as a Task Performer. In the second region 506 of the display, tasks, such as task 510, are displayed which require action by others, both as Task Performers and Task Assignors.

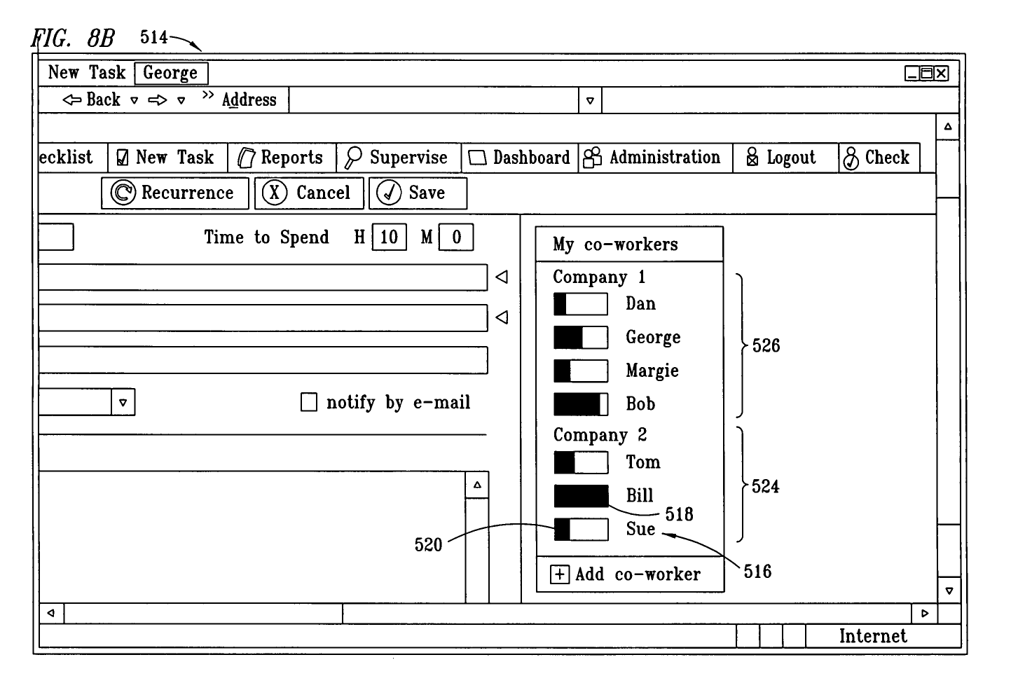

FIGS. 8A and 8B are a representation of a task entry display 514 in accordance with an exemplary embodiment of the present invention. Task entry display 514 includes a task available time display 516 provided for potential Task Performers, which can be used either by a Task Assignor in assigning a task, or by a Task Performer in determining whether to accept a particular task. The task available time display 516 is preferably a graphical display of the total time of the potential Task Performers, in which graphical representations, such as gas tanks 518 and 520, show the time allotted for assigned tasks and the remaining time available for performance of new tasks for potential task performers. The gas tanks 518 and 520 preferably show the time already allotted as a darkened region and time not already allotted as a light colored region. The time is preferably shown as time allocated and remaining prior to the due date and time for the particular task being assigned. Non work time is also preferably accounted for in the display of the gas tanks 518 and 520. The available time display 516 is also sorted, according to user determined values, according to organizations, such as region 526 for potential task performers associated with Company 1 and region 524 for potential task performers associated with Company 2. The display 516 can also include other regions for those potential performers outside of the listed organizations. A user assigning a task can quickly review the graphical representation 516 showing the gas tanks 518 and 520 from which the currently allotted time and available time for each user in a work group, or selected task performers from a work group, and quickly determine optimal use of available time in assigning various new tasks to particular task performers. All the potential performers in one or more work groups or business organizations are preferably shown in a single display, and others can be selectively not displayed or displayed in the task available time display 516. Performers not assigned to particular organizations can also be displayed, provided they update their respective accounts to show allocated time and available time.

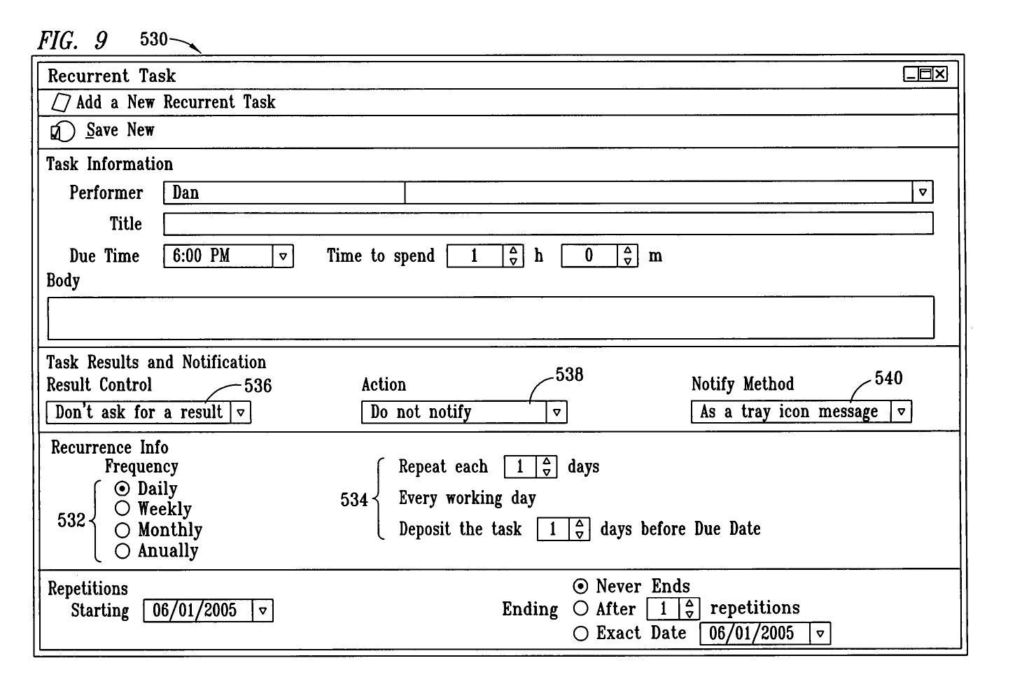

FIG. 9 is a representation showing a screen 530 for assigning recurring tasks in accordance with an exemplary embodiment of the present invention. The recurring task screen 530 provides graphical display regions 530 and 532 in which recurring task can be scheduled without requiring manual reentry of data for task which recur at regular, periodic intervals. This feature fully integrates with the method of assigning task described and shown herein, such that task result review and task approval features can be selectively enabled or disabled for particular recurring tasks assigned utilizing options selected from drop down menus 536, 538 and 540.

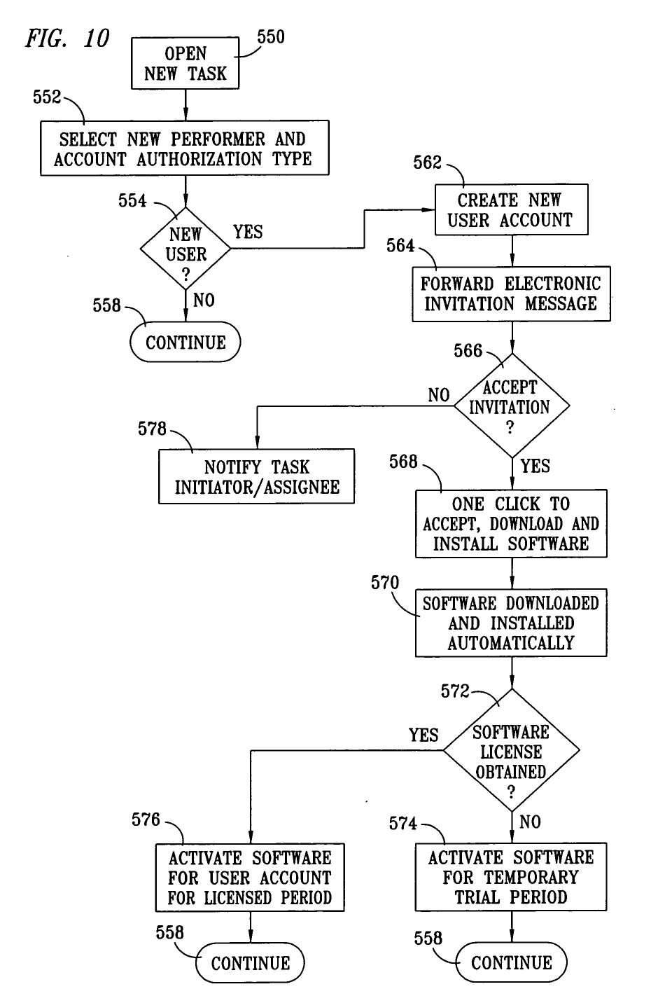

FIG. 10 is a flow chart representing a method of task management for assigning tasks to new users, which can include others outside of the organization in which the task Assignor is operating, in accordance with an exemplary embodiment of the present invention. The process proceeds as in step 14, in FIG. 1, with step 550, in which an Assignor initiating a task will open a new task. In step 552, the task Assignor can select a potential Task Performer who is not a user and/or which is not associated with his organization, and not presently in the system for assigning tasks. When a Task Performer is selected which does not have a user account, the Assignor, if having the appropriate authority on the system, assigns an account type to the potential task performer. If the Assignor does not have the appropriate system authority, authority must be obtain from a user having an account status for assigning and establishing new user accounts, and/or an Assignor having system authority to establish a new account for a new user outside of the organization. Preferably, each user will have authority to assign tasks to new users, creating new user accounts which initiates an electronic message to click on a link which automatically downloads and installs the software for task management, linking the new user in the database for managing tasks. Each new user will also preferably have authority to create new user accounts by assigning tasks to others who have not yet become users. These later new users can also create new user accounts by assigning tasks to others, which forwards an electronic messaging invitation to click on a link to download and install the software. Preferably, one click on the link will download and install the software and then open a display showing the task monitor from which the newly assigned task can be displayed. The new accounts can be activated by assigning a performer's previously purchased license to the new performer, if accepted, or the activation can be a temporary trial period activation, such as for a 30 or 60 period, or such, or to assign the account a temporary trial period for the software trial. In some embodiments, a version of software having features deactivated can be downloaded, such as a light version of the software. In the decision block 554, the system determines whether a task Performer is selected for which a user account has not been created, and whether the Assignor has appropriate authority to establish such an account. As noted above, preferably, each user has authority to create new accounts, for which licenses must later be purchased by new users or existing licenses of the task performer must be assigned.

If the task is being assigned to a current authorized user in the organization, the process proceeds to the continue 558, and continues from step 14 in FIG. 1.

If in the decision block 554 it is determined that the new Task Performer is not a current user, the process proceeds to step 562 and a new user account is created in the task management system by creating a new account for the potential Task Performer. The new account will store relevant task data whether or not a determination is made by the new potential user to accept the user account and install the related software. Then, in step 564 a message, preferably an electronic message such as an Email or other messaging, is forwarded to the new task performer inviting the new task performer to join the system for task management. If the invitee, new user does not accepts the invitation to join the system, as set forth in the decision block 566, the task initiator, or Assignor, is notified in the step 578. It should also be noted that the system reminders regarding acceptance of task are still active, such as decision blocks 36, 40, 42, 44 and 46, and the reminder step 38 of FIG. 1. If the invitee, new task performer accepts the invitation to join the system in step 566, a link from the message can be activated to download the relevant software. Preferably, one click on the link in step 568 will automatically download and install the software, and open a task monitor screen, as shown in step 570. In decision block 572 a determination is made as to whether the new user has obtained the a software license to activate the account, either by a task performer assigning the new user a license out of a block of licenses purchased by the task Assignor, or by the new user purchasing a license. If a license has not been obtained by the new user, the software for the new user is activated for a trial period of a suitable period of time, such as 30 days, 60 days, or such. If a license has been obtained, in step 576 the software is activated for the periods set forth under the terms of the license. The new user then has access to assign tasks, create new user accounts by assigning tasks to others, and monitor and complete tasks which are stored in a main database for the task management system. The database can be a central database or a distributed database, but the new task performer's assigned tasks are available for review, acceptance, negotiation, and performance entries in the task management system by the new user and other users in the system. The new task performance account can be provided with temporary activation, such as an activation for a period of time on a trial basis, or the task Assignor initiating the task and the invitation to the system can allocate a user license to the new task performer. In other embodiments, the software downloaded to the new task performer can be a version of limited functionality, such as commonly termed a light version of the software for management tasks, or the software can be a fully functional installation, depending upon options selected by the Task Assignor in assignment of the task. The process then proceeds to the continue step 558, and moves forward from the block 14 of FIG. 1.

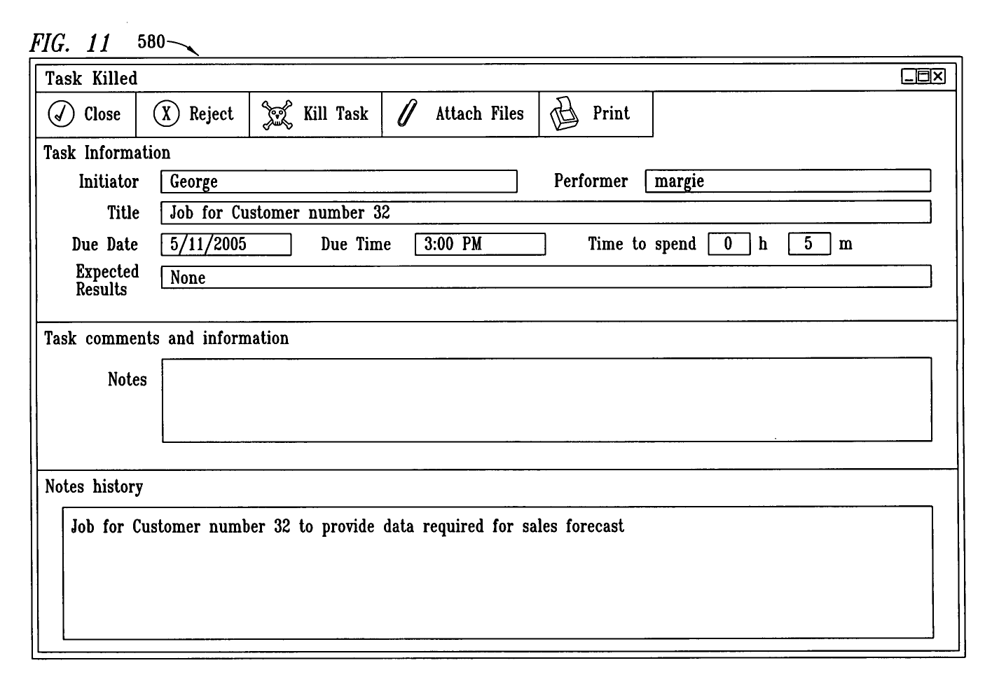

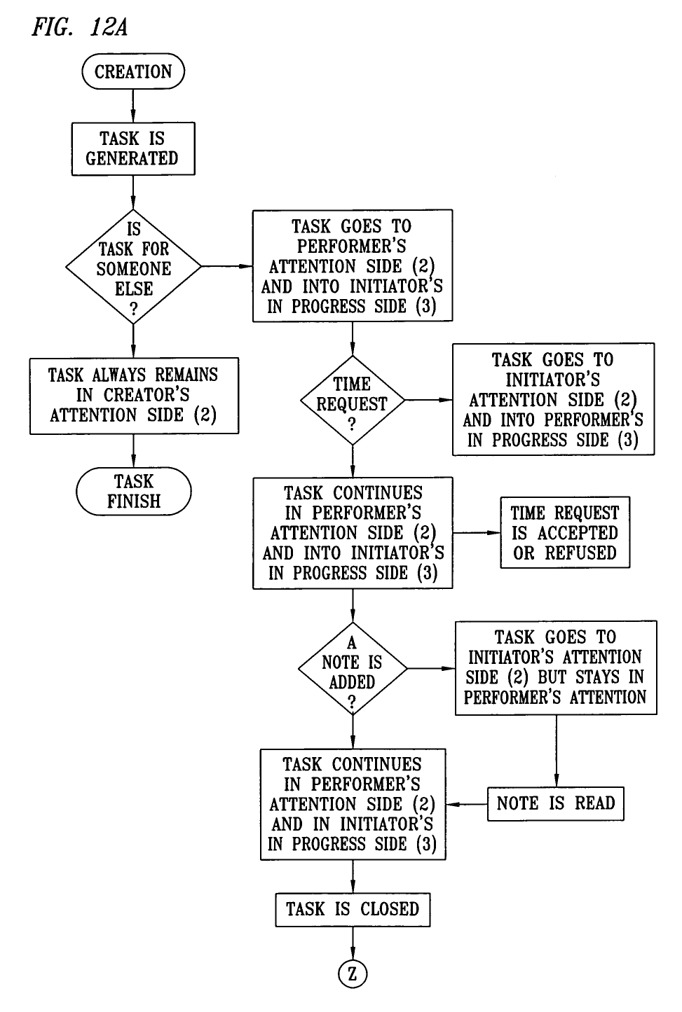

FIG. 11 is a representation of a task entry screen in accordance with an exemplary embodiment of the present invention.

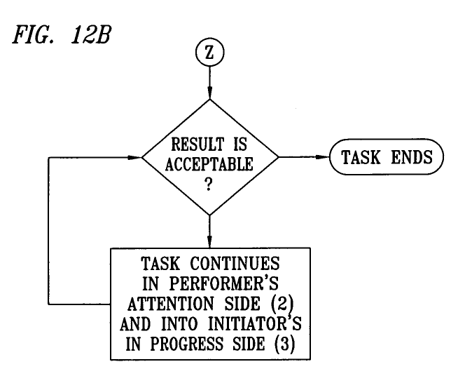

FIG. 12 is a flow chart depicting one embodiment of a task cycle in accordance with an exemplary embodiment of the present invention. The method for managing tasks with a system provides several advantages in managing tasks, from assignment to completion. The method of the present invention allows a task Initiator and a task Performer to negotiate the terms, or parameters, of the tasks being assigned. After tasks are assigned, the system tracks the performance of the task, forcing both the Initiator and the Performer to actively respond to the tracking feature of the task management system, removing the possibility of someone claiming they did not receive messages regarding assignment and performance of the tasks, automating the process for tracking and managing tasks. In some embodiments of the present invention, processes performed according to the present invention can be adapted to operate using conventional e-mail programs or conventional contact managers.

The method for managing tasks with a system allows a task Initiator and a task Performer to negotiate the terms and acceptance of tasks, and then records the actions of the Initiator and Performer in performance and tracking of the tasks. The method includes steps for defining the parameters of tasks in negotiating acceptance of the task, confirming acceptance of the tasks, performance of the tasks, and confirming performance and completion of the tasks. An Initiator will first define the initial parameters of a task, or of multiple tasks which comprise a project. Next, the Initiator and Performer will negotiate the parameters and acceptance of the task. Completion of various parameters of the task are tracked and confirmed by the Initiator and Performer as the task is performed. Upon completion of the tasks, both the Performer and the Initiator confirm completion and closing of the task.

Various exemplary embodiments of the invention are now described in greater detail. One exemplary embodiment of the invention includes a method for managing a task. The method comprises an Initiator defining a first set of parameters for the task. The task is assigned to a Performer and monitored to determine whether the Performer has been informed of the existence of the task after the step of assigning the task to the Performer. If not, a reminder is forwarded to the Initiator and the Performer regarding the task. The Performer is again informed of the task and the first set of parameters for the task. The task is then monitored to determine whether the Performer has noted the task a complete after informing the Performer of the task. If the task is not noted as completed after a predetermined time interval, a reminder is forwarded to the Initiator and the Performer regarding the task. After performance of the task, the Performer notes the task as complete. The Initiator is informed of the Performer noting the task as complete, and the task is monitored to determine whether the Initiator has noted the task as closed after informing the Initiator of the task. If the task is not noted as closed after a predetermined time interval, a reminder is forwarded to the Initiator and the Performer regarding the task, after which the Initiator closes the task.

The method can also include the Performer reviewing the first set of parameters for the task and determining whether to accept the task as defined according to the first set of parameters. If the performer does not accept the task as defined according to the first set of parameters, they propose a second set of parameters for the task. The Initiator reviews the second set of parameters and determines whether to accept the task as defined according to the second set of parameters or to proposed changes top the second set of parameters.

The method can also include both the Initiator and the Performer accepting the task as defined according to the second set of parameters.

The method can also include monitoring to determine whether the Initiator and the Performer have accepted the task as defined by the then modified parameters. If the task has not been accepted by both the Initiator and the Performer after a predetermined time interval, a reminder is forwarded to the Initiator and the Performer regarding the task.

The method can also include the Initiator rating the Performer's performance of the task after the Initiator is informed of the Performer's completion of the task.

The method can also include monitoring to determine whether the Initiator has rated the Performer's performance of the task, and if the task has not been rated by the Initiator after a predetermined time interval, forwarding a reminder to the Initiator and the Performer regarding the task.

The method can also include creating a new task in response to unsatisfactory performance of the task by the Performer.

In another exemplary embodiment, a method for managing a task is provided that includes an Initiator defining a first set of parameters for the task and assigning the task to a Performer. The task is monitored to determine whether the Performer has been informed of the existence of the task after the step of assigning the task to the Performer, and if not, forwarding a reminder to the Initiator and the Performer regarding the task. The Performer is informed of the task and the first set of parameters for the task, and the Performer reviews the first set of parameters for the task. The Performer determines whether to accept the task as defined according to the first set of parameters, and if not, the Performer proposes a second set of parameters for the task. The Initiator reviews the second set of parameters and determining whether to accept the task as defined according to the second set of parameters or to proposed changes top the second set of parameters. After both the Initiator and the Performer accept the task as defined according to the second set of parameters, it is monitored to determine whether the Initiator and the Performer have accepted the task as defined by the then modified parameters. If the task has not been accepted by both the Initiator and the Performer after a predetermined time interval, a reminder is forwarded to the Initiator and the Performer regarding the task. The task is further monitored to determine whether the Performer has noted the task a complete after informing the Performer of the task. If the task is not noted as completed after a time interval, a reminder is forwarded to the Initiator and the Performer regarding the task. After performance of the task, the Performer notes the task as complete. The Initiator is informed of the Performer noting the task as complete. The task is monitored to determine whether the Initiator has noted the task as closed after informing the Initiator of the task. If the task is not noted as closed after a predetermined time interval, a reminder is forwarded to the Initiator and the Performer regarding the task. The Initiator closing the task, and rates the Performer's performance of the task after the Initiator is informed of the Performer's completion of the task.

The exemplary method can also include monitoring to determine whether the Initiator has rated the Performer's performance of the task. If the task has not been rated by the Initiator after a time interval, a reminder is forwarded to the Initiator and the Performer regarding the task.

The exemplary method can also include creating a new task in response to unsatisfactory performance of the task by the Performer.

The exemplary method can also include automatically determining whether the Performer can complete a proposed task according to the time deadlines set forth in parameters of the task.

The exemplary method can also include notifying the Performer that the Initiator has opened a completed task.

The exemplary method can also include notifying the Performer of a task being proposed by the Initiator by electronic messaging.

The exemplary method can also include notifying the Performer of an electronic message by suitable means.

The exemplary method can also include automatically closing the task after passing of the due date defined for the task.

Another exemplary embodiment of the invention is a method for assigning, accepting, negotiating, performing, completing and closing a Task between an Initiator and Performer. The method includes the Initiator assigning a new task specifying scope, the Performer to do it and time completion required. The system records the new task and sends it to Performer as well as tracks and reminds the Performer that he has a new task. The system also tracks the task and reminds the Initiator if the Performer has not accepted the task. The Performer receives the task and will either accept it as requested and start performing, or reject it and propose counter terms to the Initiator. The system records the Performer's acceptance of task and tracks and reminds Performer of due date as well as tracks and reminds Initiator of due date. If the Performer proposed different terms to the Initiator, the Initiator can accept the Performer's different terms or reject them. The system records the Performer's counter terms of task and notifies Initiator, and tracks and reminds Initiator that the task has not been accepted by the Performer and that the Initiator must respond to the Performer's counter offer. The system tracks and reminds the Performer that the Initiator has not responded to the Performer's counter proposal.

In this exemplary embodiment, if the Initiator rejects the terms of the Performer, the Initiator will propose different terms to the Performer. The system records the Initiator's terms for the task and notifies the Performer. The system tracks the task and reminds the Initiator that the task has not been accepted by the Performer and that the Performer must respond to the Initiator. The system tracks and reminds the Initiator that the Performer has not responded to the Initiator's counter proposal. These steps can be repeated until the Performer accepts the terms proposed by the Initiator without changes or until the Initiator accepts terms proposed by the Performer without changes.

When the Performer has accepted terms, he starts working on task until completion. The system records that task has been accepted and notifies the Performer and the Initiator that the task is accepted. The system tracks the task and reminds the Performer of the accepted task. The system notifies the parties, tracks and reminds the Initiator that the accepted task is in process of being completed.

When the Performer finishes the task, the system records the task as completed and notifies the Initiator that the task is complete. The system notifies the Performer that the Initiator has not acknowledged the Performer that the task is complete. When the Initiator acknowledges that the task is completed, the Initiator closes task. The system tracks that the task is complete and notifies the Performer of the Initiator's acknowledgment that the task is complete. The system closes the task and the Initiator and Performer are relived of their individual responsibilities for that task.

In another exemplary embodiment, the system notifies and sends the actions or lack of actions by the Initiator to the Performer. The system notifies and sends the actions or lack of actions by the Performer to the Initiator. The system places Time stamps at each step, and the steps are stored in the system. The steps and information related to it are communicated over a LAN, WAN, handheld devices and/or Internet and/or a combination of them, and displayed by a computer or device screen, voice, text, sound, special formatting of text, and or a combination of them.

The exemplary method can also include assigning, accepting, negotiating, performing, completing and closing a Task between the Initiator and the Performer and where the responsibility of completing each step passes individually from one party, such as the Initiator to the Performer and vice versa. The system can simultaneously create a verification responsibility to the other party, for the Performer or the Initiator to verify, track and report that the responsibility. The system can also include functionality such that when the Initiator assigns a new task, the Performer is notified. The Initiator is also notified that the task has been sent to the Performer.

In this exemplary embodiment, when the Performer receives the task the system creates a verification responsibility for the Initiator to verify that the Performer reads the task and either accepts it or proposes different terms. When the Performer reads or confirms receipt of the task, the system creates a verification responsibility for the Initiator to verify that the Performer either accepts or proposes different terms. When the Performer accepts the task the system creates a verification responsibility for the Initiator to verify that the task is completed on the agreed upon date/terms. When the Performer starts performing the task, the system creates a verification responsibility for the Initiator to verify that the task is completed on the agreed upon date/terms.

When the Performer rejects the task, the system notifies the Initiator that the Performer rejected the task. When the Performer proposes counter terms to the Initiator, the system sends counter terms to the Initiator and creates a verification responsibility for the Performer to verify that the Initiator reads the counter terms and either accepts it or proposes different terms. When the Initiator receives new terms the system creates a verification responsibility for the Performer to verify that the Initiator reads the counter terms and either accepts it or proposes different terms. When the Initiator accepts the terms the system Notifies the Performer that terms have been accepted and that the Performer has responsibility to perform according to terms. The system creates a verification responsibility for the Initiator to verify that the Performer is notified that the task has been accepted by the Performer. The system creates a verification responsibility for the Initiator to verify that the task is completed on the agreed upon date/terms.

When the Initiator rejects different terms, the Initiator proposes different terms to the Performer. The system sends the task to the Performer and creates a verification responsibility for the Initiator to verify that the Performer reads the task and either accepts it or proposes different terms. When the Initiator proposes different terms to the Performer the system sends the task to the Performer and creates a verification responsibility for the Initiator to verify that the Performer reads the task and either accepts it or proposes different terms. When the Performer receives new terms, the system creates a verification responsibility for the Initiator to verify that the Performer reads new terms and either accepts it or proposes different terms and so on until both the Initiator and the Performer accept without changes.

When the Performer accepts the proposal, the system creates a verification responsibility for the Initiator to verify that the task is completed on the agreed upon date/terms. When the Performer works on the task, the system creates a verification responsibility for the Initiator to verify that the task is completed on the agreed upon date/terms. When the Performer completes the task, the system sends the task to the Initiator and creates a verification responsibility for the Performer to verify that the Initiator reads the completed the task.

When the Initiator receives notification that the task is complete, the system creates a verification responsibility for the Performer to verify that the Initiator reads the completed the task. When the Initiator reads that the task is complete, the system notifies the Performer that the Initiator is aware of completion of the task and the system relieves the Performer of all its obligations for that the task. When the Initiator closes the task the system relieves the Initiator of all its obligations for that task.

In another exemplary embodiment, system monitors, records and reports the performance of individually accepted responsibilities of the Initiator and/or the Performer when they are assigning, accepting, negotiating, performing, completing or closing a Task between the Initiator and the Performer. A computer the system records and places a time stamp when the Initiator assigns a new task, the Performer receives a task, the Performer reads or confirms receipt of the task, the Performer accepts the task, the Performer start performing the task, the Performer rejects the task, the Performer proposes counter terms to the Initiator, the Initiator receives new terms, the Initiator accepts terms, the Initiator rejected different terms, the Initiator proposes different terms to the Performer, the Performer receives new terms, the Performer accepts proposal, the Performer works on the task, the Performer completes the task, the Initiator receives notification that task is complete, the Initiator acknowledges that the task is complete, and the Initiator Closes Task. Reports are generated by the system of any of the above time stamps using customizable criteria, as defined by the Performer, the Initiator, or other suitable parties. The Performer and the Initiator negotiate the terms of a task and where both parties can accept or reject the terms and as a result when the terms are accepted both the Initiator and the Performer become fully accountable. In this manner, neither the Performer nor the Initiator can force terms on the other. Terms have to be accepted, thus the Initiator and the Performer have to agree on terms of the task.

The exemplary method can also include assigning, accepting, negotiating, performing, completing and closing a task among an the Initiator and the Performer who can be superior, subordinate, peer or self, or assigning, accepting, negotiating, performing, completing and closing a task where the Initiator and the Performer are aware of the status of the task at the different steps of assigning, negotiating, performing and closing of a task.

In view of the above detailed description of the present invention and associated drawings, other modifications and variations are apparent to those skilled in the art. It is also apparent that such other modifications and variations can be effected without departing from the spirit and scope of the present invention.

What is claimed is:

1. A method for managing a task with a system, the method comprising the steps of:
receiving negotiated terms and acceptance of tasks from a Task Initiator and a Task Performer;
tracking performance and acceptance of completion of the tasks; and
providing a task monitor having at least two regions, the first region displaying tasks requiring action from a particular user, and a second region displaying tasks which require action by others.

2. The method of claim 1, further comprising providing a task available time display having a graphical representation of a total time of the Task Performer, which shows a time allotted for assigned tasks and a remaining time available for performance of new tasks.

3. The method of claim 1, further comprising providing a recurring task feature for assigning recurring tasks.

4. The method of claim 1, further comprising:
providing a feature for assigning tasks to others outside of the organization in which the Task Assignor is operating; and
creating an account for the new potential performer in the database for the task management system.

5. The method of claim 2 further comprising:
receiving a first set of parameters for one or more of the tasks from the Task Initiator;
assigning one or more of the tasks to a Task Performer;
determining whether the Task Performer has been informed of an existence of the one or more tasks after the step of assigning the one or more tasks to the Task Performer;
forwarding a reminder to the Task Initiator and the Task Performer regarding the one or more tasks if the Task Performer has not been informed of the existence of the one or more tasks;
determining whether the Task Performer has noted the one or more tasks complete a first time interval after informing the Task Performer of the task;
forwarding a reminder to the Task Initiator and the Task Performer regarding the one or more tasks if the Task Performer has not noted the one or more tasks complete after the first time interval;
generating a notification to the Task Initiator after performance of the one or more tasks;
monitoring to determine whether the Task Initiator has noted the one or more tasks as closed a second time period after generation of the notification; and
forwarding a reminder to the Task Initiator if the one or more tasks are not noted as closed after the second time interval.

6. The method of claim 5, further comprising:
generating a notification to the Task Performer of a first set of parameters for the one or more tasks;
receiving a second set of parameters for the one or more tasks from the Task Performer for review by the Task Initiator.

7. The method of claim 6, further comprising receiving an acceptance from the Task Initiator of the second set of parameters.

8. The method of claim 7, further comprising:
monitoring to determine whether the Task Initiator has accepted the second set of parameters after a third time interval; and
forwarding a reminder to the Task Initiator if the Task Initiator has not accepted the second set of parameters after the third time interval.

9. The method of claim 8, further comprising receiving a rating the Task Performer after completion of the one or more tasks.

10. The method of claim 9 further comprising creating a new task in response to an unsatisfactory rating of the Task Performer.

11. A method for managing a task with a system, the method comprising the steps of:
receiving negotiated terms from a Task Initiator and a Task Performer for one or more tasks;
tracking performance and acceptance of completion of the one or more tasks; and
providing a task available time display the Task Performer that includes a graphical representation of a total time of the Task Performer, which shows an allotted time for each of the one or more tasks and a remaining time available for each of the one or more tasks.

12. The method of claim 11 further comprising providing a recurring task feature for assigning recurring tasks.

13. The method of claim 11 further comprising:
providing a feature is for assigning tasks to a new Task Performer, the feature creating an account for the new Task Performer; and
forwarding a message to the new Task Performer with a link that causes the system to automatically download and install software for interfacing with the system.

14. The method of claim 11, comprising:
receiving a first set of parameters for the one or more tasks from the Task Initiator;
notifying the Task Performer of the first set of parameters;
receiving a second set of parameters for the one or more tasks from the Task Performer;
notifying the Task Initiator of the second set of parameters; and
receiving an acceptance of the second set of parameters from the Task Initiator.
